(19) United States
(12) Patent Application Publication
(10) Pub. No.: US 2025/0047345 A1
(43) Pub. Date: Feb. 6, 2025

(54) REPORTING CHANNEL STATE INFORMATION FOR RESOURCES WITH DIFFERENT PERIODICITIES

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/717,272

(22) PCT Filed: Feb. 2, 2022
(86) PCT No.: PCT/CN2022/075310

§ 371 Date: Jun. 6, 2024

(51) Int. Cl. H04B 7/06; H04B 17/318

(52) U.S. Cl. CPC H04B 7/0626; H04B 7/06968; H04B 17/328

(57) ABSTRACT

Certain aspects of the present disclosure provide techniques for configuring and reporting channel state information for resources with different periodicities. A method that may be performed by a user equipment includes receiving a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources; and reporting CSI associated with the first group, the second group, or the first group and the second group of one or more monitored CSI-RS or SSB resources.

### INTRODUCTION

Aspects of the present disclosure relate to wireless communications, and more particularly, to techniques for configuring and reporting channel state information.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include wide beam based properties for narrow beam resources.

Certain aspects of the subject matter described in this disclosure can be implemented in a method for wireless communication by a user equipment (UE). The method generally includes receiving a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources; and reporting CSI associated with the first group, the second group, or the first group and the second group of one or more monitored CSI-RS or SSB resources.

Certain aspects of the subject matter described in this disclosure can be implemented in a method for wireless communication by a network entity. The method generally includes sending, to a UE, a CSI report setting associated with at least one resource setting indicating a first group of one or more CSI-RS or SSB resources and a second group of one or more CSI-RS or SSB resources for measuring CSI, the first group of one or more CSI-RS or SSB resources having a different periodicity than the second group of one or more CSI-RS or SSB resources; sending one or more signals associated with the first group, the second group, or the first group and the second group of one or more CSI-RS or SSB resources; and obtaining, from the UE, CSI associated with at least one of the one or more signals.

Certain aspects of the subject matter described in this disclosure can be implemented in an apparatus for wireless communication. The apparatus generally includes a memory and a processor coupled to the memory. The processor is configured to cause the apparatus to receive a CSI report setting associated with at least one resource setting that indicates a first group of one or more CSI-RS or SSB resources and a second group of one or more CSI-RS or SSB resources, the first group of one or more CSI-RS or SSB resources having a different periodicity than the second group of one or more CSI-RS or SSB resources. The processor is further configured to cause the apparatus to report CSI associated with the first group, the second group, or the first group and the second group of one or more monitored CSI-RS or SSB resources.

Certain aspects of the subject matter described in this disclosure can be implemented in an apparatus for wireless communication. The apparatus generally includes a memory and a processor coupled to the memory. The processor is configured to cause the apparatus to send, to a UE, a CSI report setting associated with at least one resource setting indicating a first group of one or more CSI-RS or SSB resources and a second group of one or more CSI-RS or SSB resources for measuring CSI, the first group of one or more CSI-RS or SSB resources having a different periodicity than the second group of one or more CSI-RS or SSB resources. The processor is further configured to cause the apparatus to send one or more signals associated with the first group, the second group, or the first group and the second group of one or more CSI-RS or SSB resources. The processor is also configured to cause the apparatus to obtain, from the UE, CSI associated with at least one of the one or more signals.

Certain aspects of the subject matter described in this disclosure can be implemented in an apparatus for wireless communication. The apparatus generally includes means for receiving a CSI report setting associated with at least one resource setting that indicates a first group of one or more CSI-RS or SSB resources and a second group of one or more CSI-RS or SSB resources, the first group of one or more CSI-RS or SSB resources having a different periodicity than the second group of one or more CSI-RS or SSB resources; and means for reporting CSI associated with the first group, the second group, or the first group and the second group of one or more monitored CSI-RS or SSB resources.

Certain aspects of the subject matter described in this disclosure can be implemented in an apparatus for wireless communication. The apparatus generally includes means for sending, to a UE, a CSI report setting associated with at least one resource setting indicating a first group of one or more CSI-RS or SSB resources and a second group of one or more CSI-RS or SSB resources for measuring CSI, the first group of one or more CSI-RS or SSB resources having a different periodicity than the second group of one or more CSI-RS or SSB resources; means for sending one or more signals associated with the first group, the second group, or the first group and the second group of one or more CSI-RS or SSB resources; and means for obtaining, from the UE, CSI associated with at least one of the one or more signals.

Certain aspects of the subject matter described in this disclosure can be implemented in a computer-readable medium. The computer-readable medium has instructions stored thereon, that when executed by an apparatus, cause the apparatus to perform operations including receiving a CSI report setting associated with at least one resource setting that indicates a first group of one or more CSI-RS or SSB resources and a second group of one or more CSI-RS or SSB resources, the first group of one or more CSI-RS or SSB resources having a different periodicity than the second group of one or more CSI-RS or SSB resources; and reporting CSI associated with the first group, the second group, or the first group and the second group of one or more monitored CSI-RS or SSB resources.

Certain aspects of the subject matter described in this disclosure can be implemented in a computer-readable medium. The computer-readable medium has instructions stored thereon, that when executed by an apparatus, cause the apparatus to perform operations including sending, to a UE, a CSI report setting associated with at least one resource setting indicating a first group of one or more CSI-RS or SSB resources and a second group of one or more CSI-RS or SSB resources for measuring CSI, the first group of one or more CSI-RS or SSB resources having a different periodicity than the second group of one or more CSI-RS or SSB resources; sending one or more signals associated with the first group, the second group, or the first group and the second group of one or more CSI-RS or SSB resources; and obtaining, from the UE, CSI associated with at least one of the one or more signals.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4 is a diagram illustrating example operations where beam management may be performed.

FIGS. 5A and 5B illustrate an example of hierarchical beam refinement operations between a base station (e.g., a gNB) and a user equipment.

FIG. 6 is a diagram illustrating an example operation of estimating or predicting properties associated with narrow beams using wide beams.

FIG. 7 is a diagram illustrating an example of reference signal transmissions having different periodicities.

FIG. 8 is a diagram illustrating an example of resource associations for resources with different periodicities.

FIG. 9 is a signaling flow illustrating an example of reporting channel state information (CSI) for reference signals with different periodicities.

FIG. 10 is a diagram illustrating an example CSI report setting associated with groups of resources having different periodicities.

FIG. 11 is a diagram illustrating an example CSI report setting associated with an example CSI resource setting with separate resource sets for resources having different periodicities.

FIG. 12 is a diagram of two example CSI report settings, where each of the CSI report setting is associated with resources with a different periodicity.

FIGS. 13A and 13B are diagrams illustrating example associations between resources.

FIG. 14 is a diagram illustrating example offsets of narrow beam resources within a wide beam resource.

FIG. 15 is a flow diagram illustrating example operations for wireless communication, for example, by a user equipment.

FIG. 16 is a flow diagram illustrating example operations for wireless communication, for example, by a network entity.

FIG. 17 is a diagram illustrating an example disaggregated base station architecture.

FIG. 18 depicts aspects of an example communications device.

FIG. 19 depicts aspects of an example communications device.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatuses, methods, processing systems, and computer-readable mediums for configuring and reporting channel state information (CSI) for groups of CSI reference signal (CSI-RS) resources or synchronization signal block (SSB) resources configured with different periodicities. As used herein, a CSI-RS/SSB resource may correspond to one or more frequency resources, one or more time resources, or one or more time-frequency resource for the respective CSI-RS and/or SSB. For example, for one group of CSI-RS/SSB resources, the resources may recur with a first periodicity, and for another group of CSI-RS/SSB resources, the resources may recur with a second periodicity that is different than the first periodicity.

In certain wireless communication networks (e.g., 5G New Radio), the network may transmit CSI-RS/SSB using the CSI-RS/SSB resources, wherein certain CSI-RS/SSB resources are used for wide beam transmissions, and certain CSI-RS/SSB resources are used for narrow beam transmissions. A wide beam may be referred to as such as it may cover a wider spatial area (e.g., a wider beam shape, radiation pattern, or beam size) than a narrow beam. As such, the terms wide beam and narrow beam may be relative to one another. In certain cases, a wide beam may be used to estimate or predict properties associated with one or more narrow beams. According to certain examples, the CSI-RS/SSB resources used for wide beam transmission may be a first group of resources and the CSI-RS/SSB resources used for narrow beam transmissions may be a second group of resources. The first and second groups of resources may be configured to have the same periodicity in certain aspects. Such a configuration may use resources (e.g., spectral, time, and spatial) for the wide beam and narrow beam transmissions at the same time to allow the UE to use the wide beam transmissions to determine properties associated with the narrow beam transmissions, as further described herein.

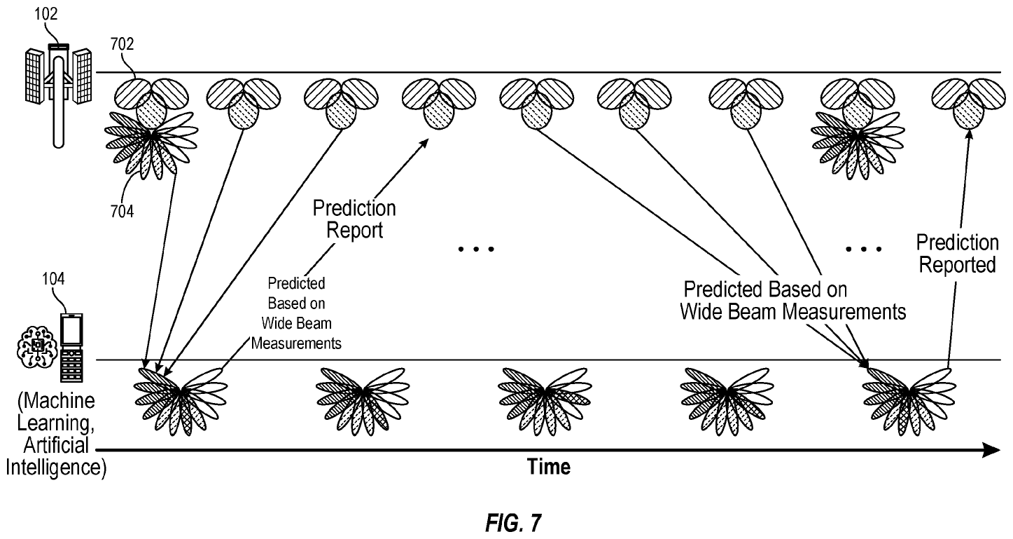

Aspects of the present disclosure provide apparatuses and methods for configuring and reporting CSI for resources with different periodicities. According to one or more examples, the UE may be configured with a CSI report setting that supports groups of CSI-RS/SSB resources with different periodicities. For example, the network may transmit wide CSI-RS/SSB beams with a short periodicity and transmit narrow CSI-RS/SSB beamss with a long periodicity as depicted in FIG. 7. In accordance with the CSI report setting, the UE may report CSI associated with the narrow CSI-RS/SSB beams based on measurements of the wide CSI-RS/SSB beams, which may be transmitted more frequently than the narrow CSI-RS/SSB beams. The network may configure the CSI-RS/SSB resource groups with different periodicities at the UE using various indications. For example, the network may configure the UE with groups of the CSI-RS/SSB resources with different periodicities in a single resource setting, multiple resource settings with different periodicities associated with a CSI report setting, or multiple CSI report settings having different periodicities with an indication that the CSI report settings are linked with each other.

The apparatuses and methods described herein may enable a reduction in UE-side beam measurements, for example, due to the UE measuring wide beams to determine properties associated with narrow beams. The reduced beam measurements at the UE may improve energy consumption at the UE. The apparatuses and methods described herein may enable the network to transmit wide beam reference signals with a short periodicity and transmit narrow beam reference signals with a long periodicity. A long periodicity may be referred to as such as it may have a period with longer duration than a short periodicity. As such, the terms long periodicity and short periodicity may be relative to one another. Such a reference signal transmission scheme may provide spectral efficiencies, which may allow for reduced latencies, increased data rates, improved user capacity, and/or reduced UE-specific overhead.

### Introduction to Wireless Communication Networks

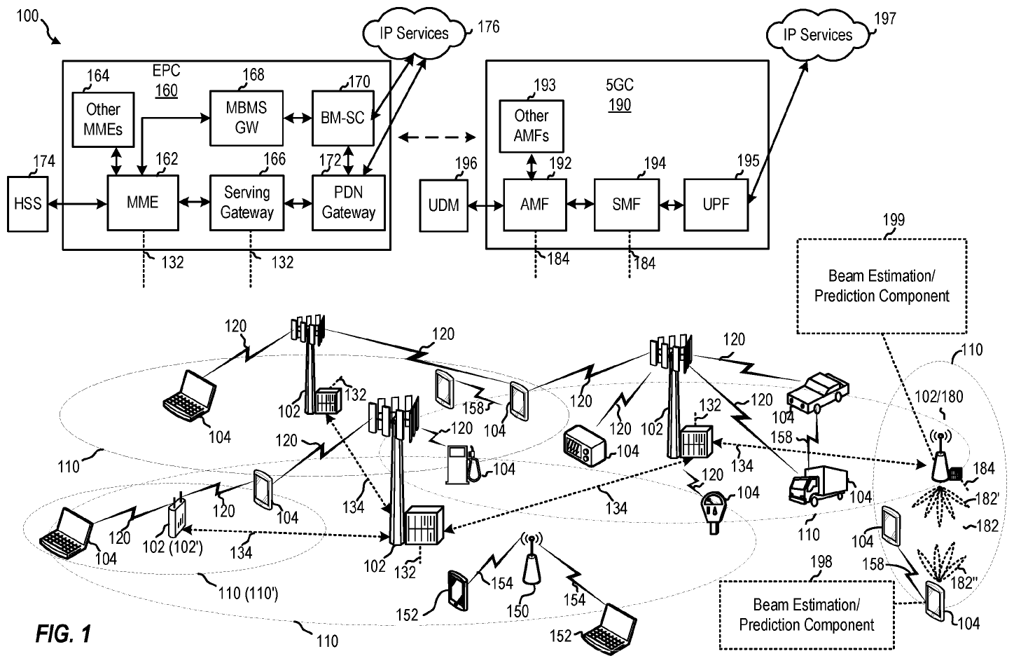

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit beams 182′. UE 104 may receive the beamformed signal from the base station 180 in one or more receive beams 182″. UE 104 may also transmit a beamformed signal to the base station 180 in one or more transmit beams 182″. Base station 180 may also receive the beamformed signal from UE 104 in one or more receive beams 182′. Base station 180 and UE 104 may then perform beam training to determine the best receive and transmit beams for each of base station 180 and UE 104. Notably, the transmit and receive beams for base station 180 may or may not be the same. Similarly, the transmit and receive beams for UE 104 may or may not be the same.

The term “beam” may be used in the present disclosure in various contexts. Beam may be used to mean a set of gains and/or phases (e.g., pre-coding weights or co-phasing weights) applied to antenna elements in the UE and/or BS for transmission or reception. The term “beam” may also refer to an antenna or radiation pattern of a signal transmitted while applying the gains and/or phases to the antenna elements. Other references to beam may include one or more properties or parameters associated with the antenna (radiation) pattern, such as angle of arrival (AoA), angle of departure (AoD), gain, phase, directivity, beam width, beam direction (with respect to a plane of reference) in terms of azimuth and elevation, peak-to-side-lobe ratio, or an antenna port associated with the antenna (radiation) pattern. The term “beam” may also refer to an associated number and/or configuration of antenna elements (e.g., a uniform linear array, a uniform rectangular array, or other uniform array).

Wireless communication network 100 includes a beam estimation/predication component 199, which may configure a UE to report CSI for CSI-RS/SSB resources with different periodicities, such as wide beam based properties for narrow beam resources. Wireless network 100 further includes a beam estimation/prediction component 198, which may report CSI for CSI-RS/SSB resources with different periodicities, such as wide beam based properties for narrow beam resources.

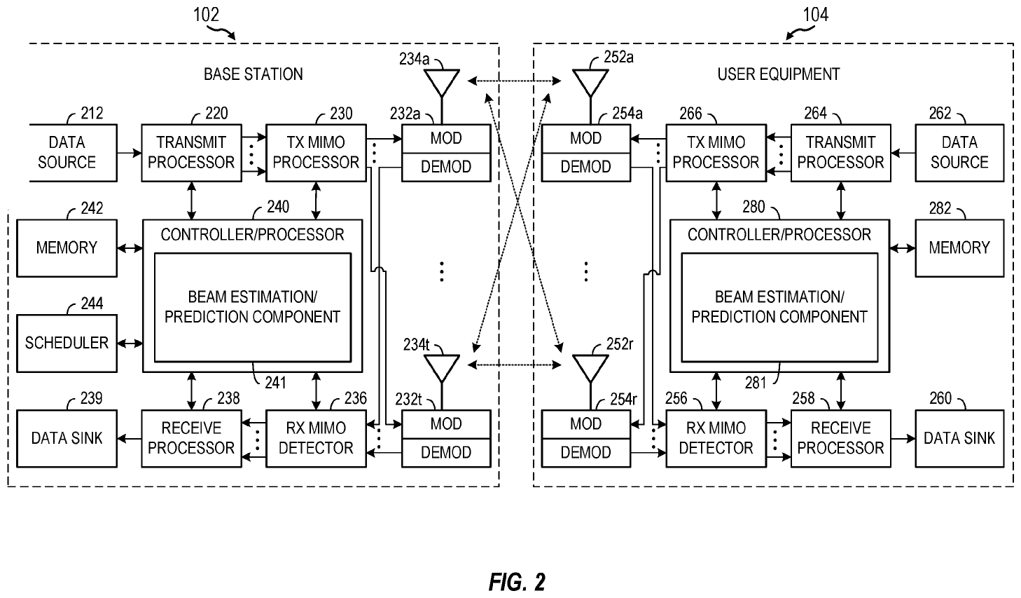

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes beam estimation/predication component 241, which may be representative of beam estimation/predication component 199 of FIG. 1. Notably, while depicted as an aspect of controller/processor 240, beam estimation/predication component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes beam estimation/predication component 281, which may be representative of the beam estimation/predication component 198 of FIG. 1. Notably, while depicted as an aspect of controller/processor 280, the beam estimation/predication component 281 may be implemented additionally or alternatively in various other aspects of user equipment 104 in other implementations.

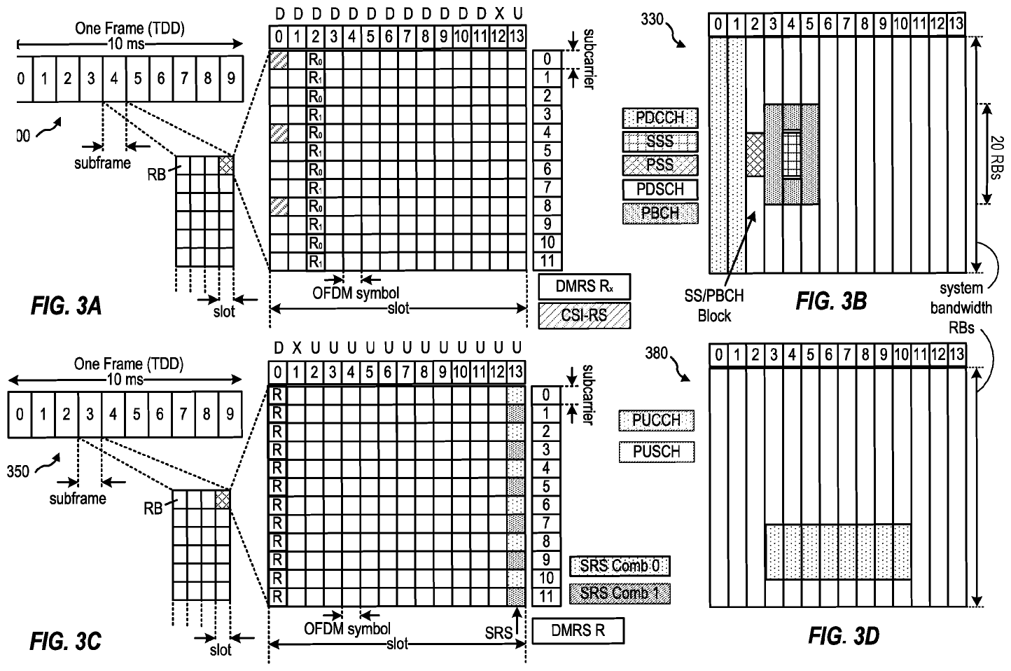

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

### Example Beam Management

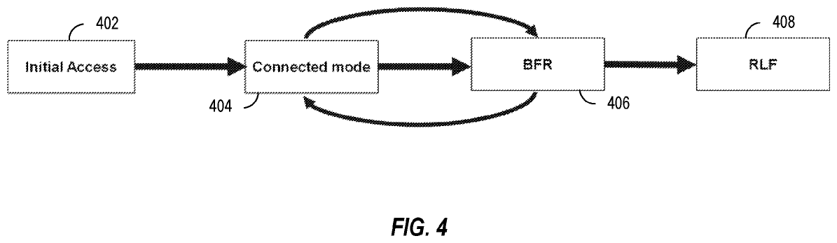

In wireless communications, various procedures may be performed for beam management. FIG. 4 is a diagram illustrating example operations where beam management may be performed. In initial access 402, the network may sweep through several beams, for example, via synchronization signal blocks (SSBs), as further described herein with respect to FIG. 3B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS).

In connected mode 404, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 406, which may allow a UE to return to connected mode 404 without performing a radio link failure procedure 408. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 408 to recover from the radio link failure, such as a RACH procedure.

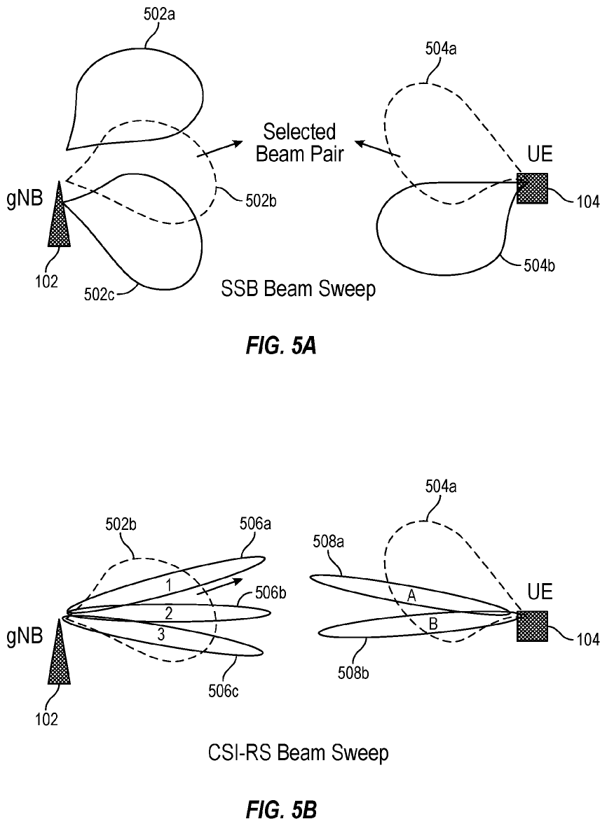

FIGS. 5A and 5B illustrate an example of hierarchical beam refinement operations between a BS 102 and a UE 104. Referring to FIG. 5A, the BS 102 may beam sweep through certain reference signals (e.g., SSBs), for example, with transmit beams 502a-c, and the UE may select a receive beam 504a associated with a particular SSB among the receive beams 504a, 504b. For example, the SSB with the best channel properties measured at the UE 104 may be selected.

Referring to FIG. 5B, the BS 102 may refine the beam selection by sweeping through narrower beams 506a-c (e.g., CSI-RSs) within the selected SSB with the transmit beam 502b. The UE may report channel properties associated with a subset of the narrower beams, for example, beams 508a, 508b at the UE 104, which may correspond to the beams 506b, 506c at the BS 102. The UE 102 may refine the receive beam selection by adjusting spatial reception parameters.

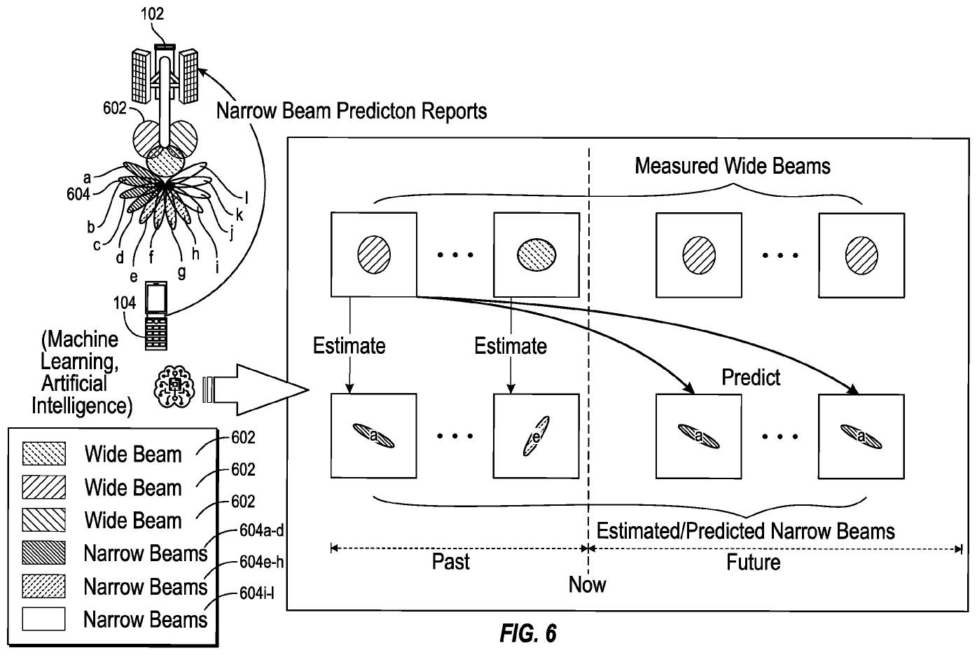

In certain aspects, a UE may estimate or predict properties associated with narrow beams (e.g., narrow beams 506a-c in the wide beam 502b as depicted in FIG. 5B) using measurements of a wide beam. FIG. 6 is a diagram illustrating an example operation of estimating or predicting properties associated with narrow beams using wide beams. In this example, the BS 102 may transmit three wide beams 602 and twelve narrow beams 604, where each of the wide beams 602 is associated with four of the narrow beams. The UE 104 may measure certain properties associated with the wide beams 602, and the UE 104 may estimate properties or predict future properties associated with one or more of the narrow beams 604 based on the measurements of the wide beams 602. In certain aspects, the UE 104 may use machine learning, regression, or artificial intelligence to determine the properties associated with the narrow beams 604 based on the measurements of the wide beams 602. The properties may include, for example, a channel quality indicator, a signal-to-noise ratio (SNR), a signal-to-interference plus noise ratio (SINR), a signal-to-noise plus distortion ratio (SNDR), a received signal strength indicator (RSSI), a reference signal received power (RSRP), a reference signal received quality (RSRQ), and/or a block error rate (BLER), for example.

### Aspects Related to Reporting Channel State Information for Resources with Different Periodicities

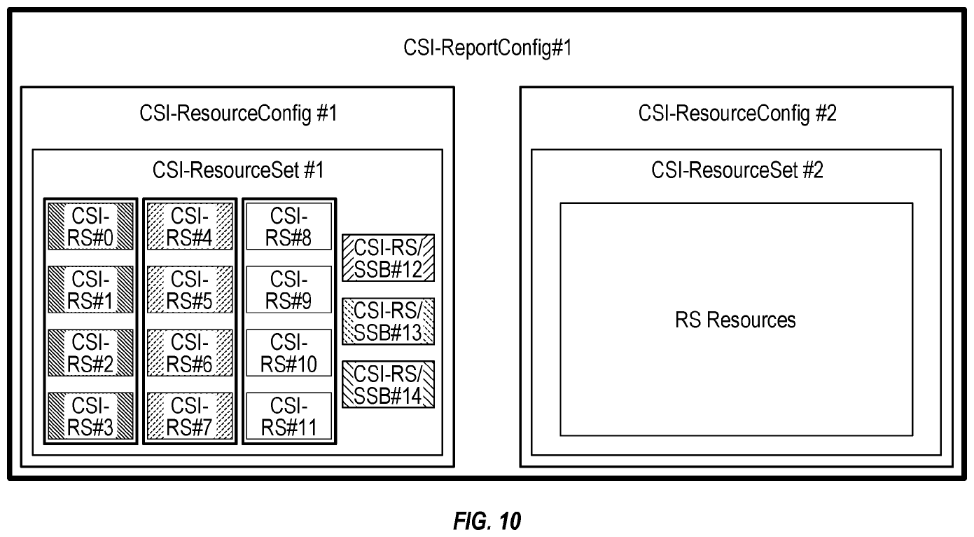

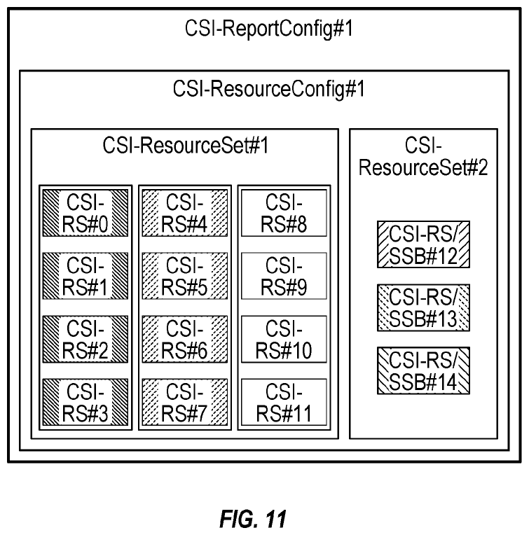

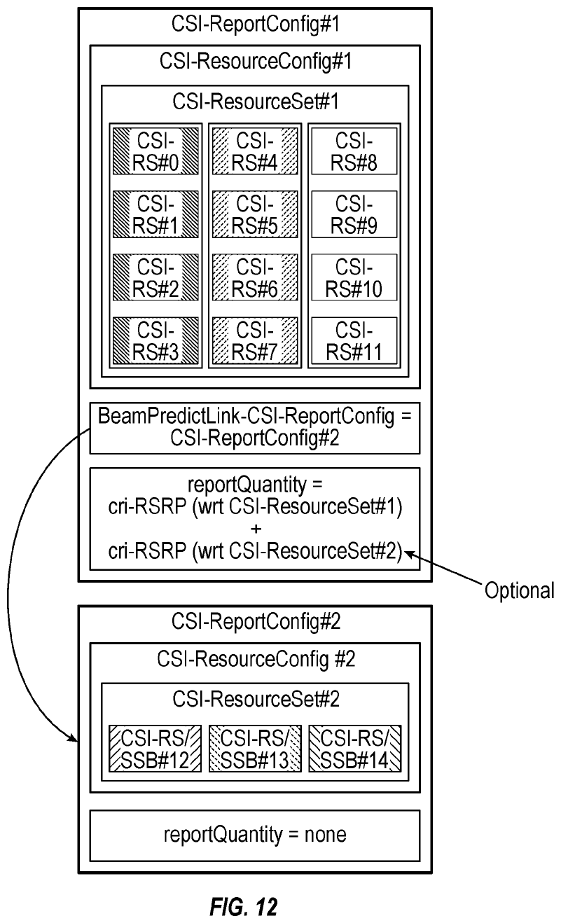

Aspects of the present disclosure provide apparatus and methods for reporting CSI for resources with different periodicities. The UE may be configured with a CSI report setting that supports groups of CSI-RS/SSB resources with different periodicities. For example, the network may transmit wide CSI-RS/SSB beams with a short periodicity and transmit narrow CSI-RS/SSB beams with a long periodicity. In accordance with the CSI report setting, the UE may report CSI associated with the narrow CSI-RS/SSB beams based on measurements of the wide CSI-RS/SSB beams, which may be transmitted more frequently than the narrow beam CSI-RSs/SSBs. The network may configure the CSI-RS/SSB resource groups with different periodicities at the UE using various indications. For example, the network may configure the UE with groups of the CSI-RS/SSB resources with different periodicities in a single resource setting (for example, as described herein with respect to FIG. 10), multiple resource settings with different periodicities associated with a CSI report setting (for example, as described herein with respect to FIG. 11), or multiple CSI report settings having different periodicities with an indication that the CSI report settings are linked with each other (for example, as described herein with respect to FIG. 12).

The apparatuses and methods described herein may enable a reduction in UE-side beam measurements, for example, due to the UE measuring wide beams to determine properties associated with narrow beams. The reduced beam measurements at the UE may improve energy consumption at the UE. The apparatuses and methods described herein may enable the network to transmit wide beam reference signals with a short periodicity and transmit narrow beam reference signals with a long periodicity. Such a reference signal transmission scheme may provide spectral efficiencies, which may allow for reduced latencies, increased data rates, improved user capacity, and/or reduced UE-specific overhead.

FIG. 7 is a diagram illustrating an example of CSI-RS/SSB transmissions having different periodicities, in accordance with certain aspects of the present disclosure. In this example, the BS 102 may transmit wide CSI-RS/SSB beams 702 with a short periodicity and transmit narrow CSI-RS/SSB beams 704 with a long periodicity. The UE 104 may use measurements of the wide CSI-RS/SSB beams 702 to determine properties associated with the narrow beam CSI-RSs/SSBs 704. In certain cases, the UE 104 may train a machine learning model or an artificial intelligence model to estimate the RSRP of one of the narrow CSI-RS/SSB beams 704 based on measurements (e.g., the RSRP) of one of the wide CSI-RS/SSB beams 702. For example, the UE 104 may develop correlations or relationships between measurements of the narrow CSI-RS/SSB beams 704 and the measurement s of the wide CSI-RS/SSB beams 702. The UE 104 may use measurements (e.g., the RSRP) of the narrow CSI-RS/SSB beams 704 and the wide CSI-RS/SSB beams 702 as training data for a machine learning model or artificial intelligence model, which may use measurements of the wide CSI-RS/SSB beams 702 as input to estimate properties associated with the narrow CSI-RS/SSB beams 704. The UE 104 may report CSI associated with the narrow CSI-RS/SSB beams 704 to the BS 102.

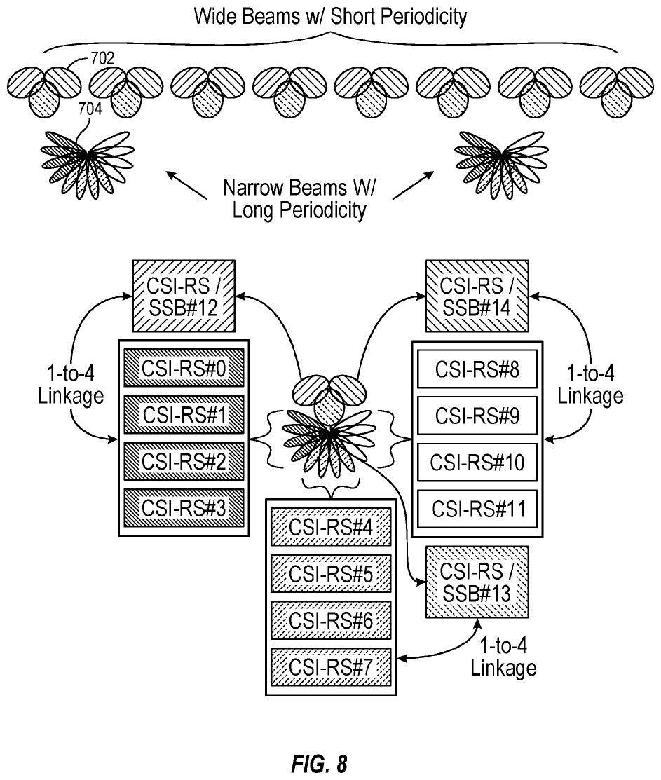

FIG. 8 is a diagram illustrating an example of CSI-RS/SSB associations for resources with different periodicities, in accordance with certain aspects of the present disclosure. In this example, there are three wide beam CSI-RS/SSB resources with a short periodicity and twelve narrow beam CSI-RS/SSB resources with a long periodicity, where each of the wide beam CSI-RS/SSB resources is associated with four of the narrow beam CSI-RS/SSB resources. For example, narrow beam CSI-RS resources 0-3 are associated with wide beam CSI-RS/SSB resource 12; narrow beam CSI-RS resources 4-7 are associated with wide beam CSI-RS/SSB resource 13; and narrow beam CSI-RS resources 8-9 are associated with wide beam CSI-RS/SSB resource 14. The narrow beam CSI-RS resources 0-3 may be beamformed within a beam shape of the wide beam CSI-RS/SSB resource 12; and so on for the other narrow beams and wide beams, in this example. In certain cases, a UE may determine properties of the narrow beams using measurements of the wide beams, for example, properties of the narrow beam CSI-RS resources 0-3 using measurements of the wide beam CSI-RS/SSB resource 12.

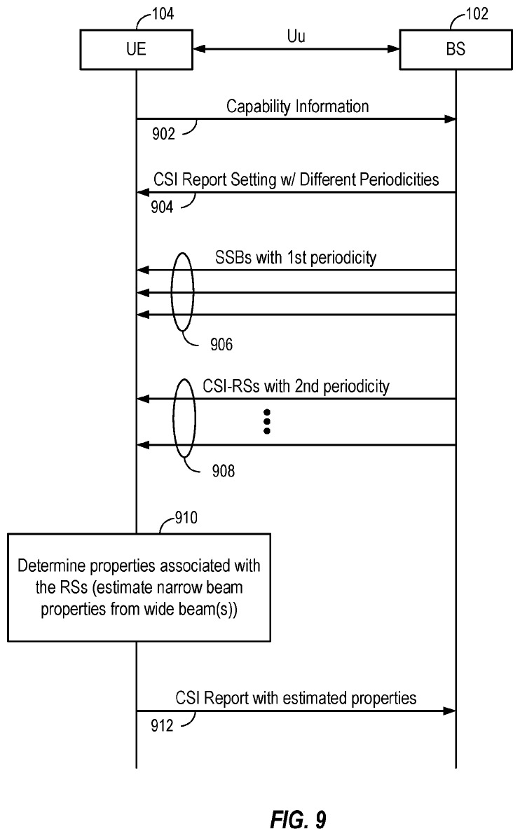

FIG. 9 is a signaling flow illustrating an example of reporting CSI for SSBs/CSI-RSs with different periodicities, in accordance with certain aspects of the present disclosure. At activity 902, the UE 104 may transmit capability information to the BS 102, where the capability information indicates that the UE 104 has a capability to report measurements associated with CSI-RS or SSB resource groups having different periodicities. For example, the UE 104 may have the capability to determine properties of narrow beam CSI-RS or SSB resources using measurements of wide beam CSI-RS or SSB resources, where the wide beam CSI-RS or SSB resources have a different periodicity than the narrow beam CSI-RS or SSB resources.

At activity 904, the UE 104 may receive a CSI report setting associated with at least one resource setting that indicates a first group of CSI-RS/SSB resources and a second group of CSI-RS/SSB resources, where the first group of CSI-RS/SSB resources has a different periodicity than the second group of CSI-RS/SSB resources. For example, the CSI report setting may be associated with a CSI resource setting that identifies a first resource set and a second resource set, where the first resource set has a different periodicity than the second resource set, for example, as further described herein with respect to FIG. 11.

At activity 906, the UE 104 may receive, from the BS 102, SSBs with a first periodicity according to the CSI resource setting associated with the CSI report setting. For example, the BS 102 may transmit three wide beam SSBs with the first periodicity. At activity 908, the UE 104 may receive, from the BS 102, CSI-RSs with a second periodicity according to the CSI resource setting associated with the CSI report setting. For example, the BS 102 may transmit twelve narrow beam CSI-RSs with the second periodicity, where each of the wide beam SSBs is associated with four of the narrow beam CSI-RSs, for example, as described herein with respect to FIG. 8. In certain aspects, the first periodicity may be shorter than the second periodicity, such that the wide beam SSBs are transmitted more frequently than the narrow beam CSI-RSs.

At activity 910, the UE 104 may determine properties associated with the CSI-RS/SSB resources. For example, the UE 104 may measure properties associated with the wide beam SSBs and determine properties associated with the narrow beam CSI-RSs based on the measured properties of the wide beam SSBs.

At activity 912, the UE 104 may send a CSI report to the BS 102, where the CSI report may indicate properties of the narrow beam CSI-RSs based on the measurements of the wide beam SSBs.

FIG. 10 is a diagram illustrating an example CSI report setting associated with groups of CSI-RS/SSB resources having different periodicities, in accordance with certain aspects of the present disclosure. In this example, a CSI report setting (e.g., CSI-ReportConfig #1) may be associated with multiple CSI resource settings (e.g., CSI-ResourceConfig #1 and CSI-ResourceConfig #2), where the first CSI resource setting (CSI-ResourceConfig #1) may identify the CSI-RS/SSB resources with different periodicities. For example, the first CSI resource setting may identify a single CSI resource set (e.g., CSI-ResourceSet #1) with CSI-RS/SSB resources having different periodicities. In the CSI resource set, the CSI-RS resources 0-11 may represent narrow beam resources with a first periodicity, and CSI-RS/SSB resources 12-14 may represent wide beam resources with a second periodicity, which may be shorter than the first periodicity. The second CSI resource setting (CSI-ResourceConfig #2) may identify resources for other CSI measurements such as interference measurements and/or channel measurements.

In certain aspects, the CSI-RS/SSB resource groups having different periodicities may be indicated in a CSI resource setting with separate resource sets for each of the different periodicities. FIG. 11 is a diagram illustrating an example CSI report setting associated with an example CSI resource setting with separate resource sets for resources having different periodicities, in accordance with certain aspects of the present disclosure. In this example, a CSI resource setting (e.g., CSI-ResourceConfig #1) associated with a CSI report setting (e.g., CSI-ReportConfig #1) may identify two periodic or semi-persistent resource sets: CSI-ResourceSet #1 and CSI-ResourceSet #2. The first CSI resource set (CSI-ResourceSet #1) may identify narrow beam CSI-RS resources with a first periodicity, and the second CSI resource set (CSI-ResourceSet #2) may identify wide beam CSI-RS/SSB resources with a second periodicity, which may be shorter than the first periodicity.

In certain aspects, the CSI-RS/SSB resource groups having different periodicities may be indicated through multiple CSI report settings. For example, FIG. 12 is a diagram of two example CSI report settings, where each of the CSI report settings is associated with CSI-RS/SSB resources with a different periodicity, in accordance with certain aspects of the present disclosure. In this example, a first CSI report setting (e.g., CSI-ReportConfig #1) may be associated with a CSI resource setting (e.g., CSI-ResourceConfig #1) that identifies the narrow beam CSI-RS resources with a first periodicity. The first CSI report setting may further indicate an association with a second CSI report setting (e.g., CSI-ReportConfig #2). For example, a separate field (e.g., BeamPredictLink-CSI-ReportConfig) may indicate the association of a CSI report setting (e.g., CSI-ReportConfig #1) with one or more other CSI report settings (e.g., CSI-ReportConfig #2). The second CSI report setting may be associated with a CSI resource setting (e.g., CSI-ResourceConfig #2) that identifies the wide beam CSI-RS/SSB resources with a second periodicity. The first CSI report setting may further indicate the properties (e.g., RSRP) to report for the CSI-RS/SSB resource groups, for example, via the field reportQuantity. For example, the field reportQuantity may indicate to report RSRPs for CSI-RS indexes (CRIs) and/or SSB indexes for the CSI-RS/SSB resources associated with first CSI report setting and/or the second CSI report setting. The second CSI report setting may indicate to report no properties associated with the CSI-RS/SSB resources (e.g., reportQuantity=none).

Those of skill in the art will understand that the CSI report settings illustrated in FIG. 12 are merely examples. Other configurations for CSI report settings may be used in addition to or instead of those illustrated for configuring the groups of CSI-RS/SSB resources with different periodicities. For example, the CSI report setting with the report quantity settings and indication of the association with another CSI report setting may be for the CSI report setting that identifies the wide beam CSI-RS/SSB resources, and the CSI report setting with report quantity set to none may be for the CSI report setting that identifies the narrow beam CSI-RS/SSB resources.

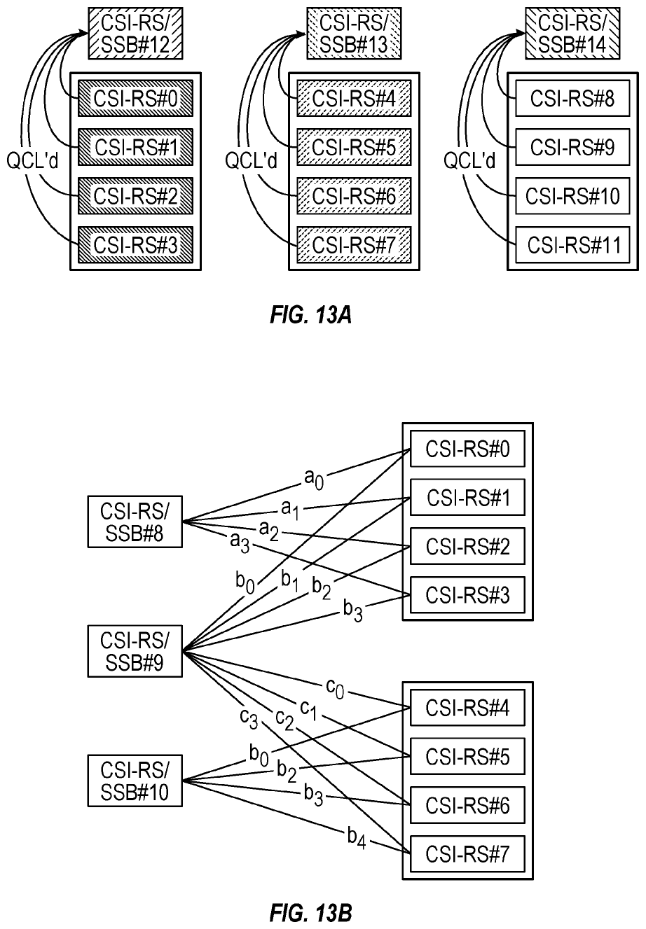

FIGS. 13A and 13B are diagrams illustrating example associations between CSI-RS/SSB resources, in accordance with certain aspects of the present disclosure. The associations depicted in FIGS. 13A and 13B may be explicitly or implicitly indicated to a UE, as further described herein. Referring to FIG. 13A, each of the wide beam CSI-RS/SSB resources may be associated with certain narrow beam CSI-RS/SSB resources, where the wide beam CSI-RS/SSB resources do not have an overlapping association with the narrow beam CSI-RS/SSB resources. For example, the wide beam to narrow beam association may be a one-to-N association (or linkage). In certain cases, the wide beam to narrow beam association may be implicitly indicated via a quasi-colocation (QCL) relationship between the wide beam to narrow beam association (e.g., a Transmission Configuration Indicator (TCI) state). For example, the CSI-RS/SSB resource 12 may have a QCL relationship with CSI-RS resources 0-3; and so on for the other wide beam resources and narrow beam resources.

QCL information and/or types may in some scenarios depend on or be a function of other information. For example, the QCL types indicated to a UE can be based on a parameter QCL-Type and may take one or a combination of the following types: QCL-TypeA: {Doppler shift, Doppler spread, average delay, delay spread}, QCL-TypeB: {Doppler shift, Doppler spread}, QCL-TypeC: {average delay, Doppler shift}, and QCL-TypeD: {Spatial Rx parameter}.

In certain aspects, a QCL assumption (or relationship) may include a frequency dispersion assumption, a time dispersion assumption, and/or a spatial assumption. The frequency dispersion assumption may include Doppler shift and/or Doppler spread, and the time dispersion assumption may include average delay and/or delay spread. The spatial assumption (e.g., spatial Rx parameters for QCL-TypeD) may include various spatial parameters for receive and/or transmit beamforming such as angle of arrival (AoA), AoA spread, dominant AoA, average AoA, Power Angular Spectrum (PAS) of AoA, angle of departure (AoD), AoD spread, average AoD, PAS of AoD, transmit/receive channel correlation, transmit/receive beamforming, spatial channel correlation, etc. The spatial QCL assumptions may enable a UE to determine a spatial filter (analog, digital, or hybrid) for beamforming a receive beam (e.g., during beam management procedures) and/or a transmit beam. For example, an SSB resource indicator may indicate that the AoA spread for a previous reference signal (e.g., the SSB) may be used for a subsequent transmission (e.g., a PDSCH transmission). In the context of wide beam based narrow beam property prediction/estimation, a QCL relationship/assumption between a wide beam CSI-RS/SSB resource and a narrow beam CSI-RS/SSB resource may indicate that the AoA (and/or other spatial parameters) for a wide beam CSI-RS/SSB resource may be used for a narrow beam CSI-RS/SSB resource.

Referring to FIG. 13B, some of the narrow beam CSI-RS/SSB resources may be associated with multiple wide beam CSI-RS/SSB resources. Some of the wide beam CSI-RS/SSB resources may have an association with narrow beam CSI-RS/SSB resources that overlaps with other wide beam CSI-RS/SSB resources. The wide beam to narrow beam association may be an M-to-N association (or linkage), for example, a 2-to-4 mapping as depicted in FIG. 13B. As shown, wide beam CSI-RS/SSB resource 8 may be associated with narrow beam CSI-RS resources 0-3; wide beam CSI-RS/SSB resource 9 may be associated with narrow beam CSI-RS resources 0-7; and wide beam CSI-RS/SSB resource 10 may be associated with narrow beam CSI-RS resources 4-7. It will be appreciated that the association of a resource with multiple resources may be representative of the resource having a wide beam shape and the other resources having a narrow beam shape arranged within the wide beam shape of the resource, for example, as described herein with respect to FIG. 8.

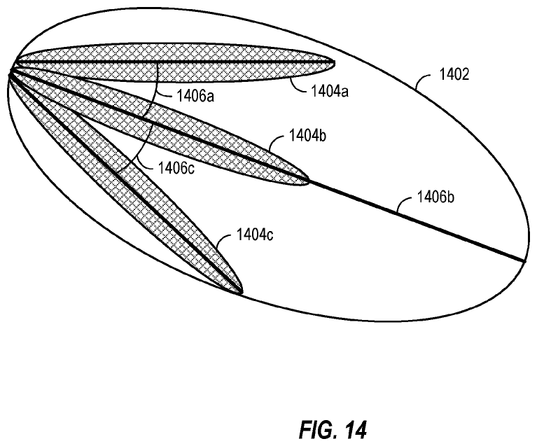

In certain aspects, the associations between CSI-RS/SSB resources may be explicitly indicated. For example, FIG. 14 is a diagram illustrating example offsets of narrow beam CSI-RS/SSB resources 1404a-c within a wide beam CSI-RS/SSB resource 1402, in accordance with certain aspects of the present disclosure. The offsets 1406a-c for the CSI-RS/SSB resources 1404a-c, respectively, may be indicated in terms of an angular metric or spatial parameter relative to the CSI-RS/SSB resource 1402. The network may configure the UE with particular values for the offsets 1406a-c. The angular metric or spatial parameter may include an angle of departure (AoD) (e.g., azimuth and/or elevation), a zenith angle of departure (ZoD), and/or a field of view (FoV). For example, the offset 1406a may be an angle of departure (e.g., 20°) for the CSI-RS/SSB resource 1406a relative to the angle of departure of the CSI-RS/SSB resource 1402, which in this example coincides with the offset 1406b); and so on for the other offsets 1406b, 1406c for the CSI-RS/SSB resources 1406b, 1406c. Those of skill in the art will understand that the offsets illustrated in FIG. 14 are merely examples. Other angular metrics or spatial parameters (e.g., a ZoD and/or a FoV) may be used in addition to or instead of those illustrated for indicating the association between CSI-RS/SSB resources.

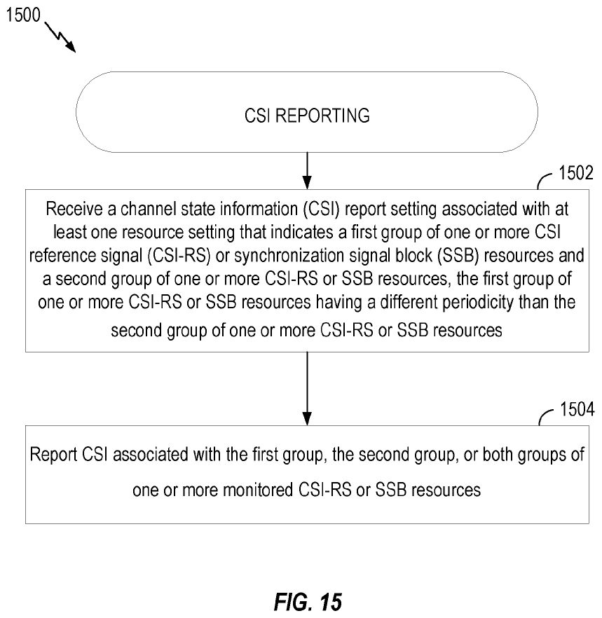

FIG. 15 is a flow diagram illustrating example operations 1500 for wireless communication, in accordance with certain aspects of the present disclosure. The operations 1500 may be performed, for example, by a UE (such as the UE 104 in the wireless communications system 100). The operations 1500 may be implemented as software components that are executed and run on one or more processors (e.g., controller/processor 280 of FIG. 2). Further, the transmission and reception of signals by the UE in operations 1500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1500 may optionally begin, at block 1502, where the UE may receive, from a network entity (e.g., the BS 102), a CSI report setting (e.g., CSI-ReportConfig #1 in FIG. 10) associated with at least one resource setting (e.g., CSI-ResourceConfig #1 in FIG. 10) that indicates a first group of one or more CSI-RS or SSB resources (e.g., CSI-RS resources 0-11 in FIG. 10) and a second group of one or more CSI-RS or SSB resources (e.g., CSI-RS/SSB resources 12-14 in FIG. 10). The first group of CSI-RS or SSB resources and second group of one or more CSI-RS or SSB resources may be periodic and/or semi-persistent resources, where the first group of one or more CSI-RS or SSB resources may have a different periodicity (e.g., a longer periodicity) than the second group of one or more CSI-RS or SSB resources. In certain aspects, the UE may receive any of the CSI report settings described herein with respect to FIGS. 10-12. As an example, the first group of CSI-RS or SSB resources may be narrow beam resources with a long periodicity, and the second group of CSI-RS or SSB resources may be wide beam resources with a short periodicity, for example, as described herein with respect to FIGS. 7 and 8. As used herein, one or more CSI-RS or SSB resources may refer to one or more CSI-RS resources and/or one or more SSB resources.

At block 1504, the UE may report, to the network entity, CSI associated with the first group, the second group, or both groups (the first and second groups) of one or more monitored CSI-RS or SSB resources. For example, the UE may monitor for CSI-RSs/SSBs in the second group of CSI-RS or SSB resources, which may have a shorter periodicity than the first group of CSI-RS or SSB resources, for example, as illustrated in FIG. 9. The UE may measure properties associated with the second group of CSI-RS or SSB resources based on the received CSI-RSs/SSBs in the second group of CSI-RS or SSB resources. The UE may determine properties associated with the first group of CSI-RS or SSB resources based at least in part on the measured properties associated with the second group of CSI-RS or SSB resources, for example, with machine learning as described herein with respect to FIG. 6. The UE may report (e.g., transmit) the CSI, which may indicate the properties (e.g., RSRPs for CSI-RSs/SSBs) associated with the first group of CSI-RS or SSB resources, to the network entity, for example.

For certain aspects, the first group of CSI-RS or SSB resources may have a different number of resources (e.g., a greater number of resources) than the second group of CSI-RS or SSB resources. As an example, the first group of CSI-RS or SSB resources may have a longer periodicity than the second group of CSI-RS or SSB resources, and the first group of CSI-RS or SSB resources may have more resources than the second group of CSI-RS or SSB resources. In certain cases, the first group of CSI-RS or SSB resources may be representative of narrow beam resources that are arranged within the beam shapes of the second group of CSI-RS or SSB resources, which may be representative of wide beam resources, for example, as described herein with respect to FIG. 8.

In certain aspects, the UE may provide capability information related to reporting CSI for resources with different periodicities to the network entity, for example, as described herein with respect to FIG. 9. For example, the UE may transmit, to the network entity, an indication that the UE has a capability to report measurements associated with CSI-RS or SSB resource groups (e.g., the first and second groups) having different periodicities, such as the first group and second group of CSI-RS SSB resources.

For certain aspects, the first group of CSI-RS or SSB resources may be associated with the second group of CSI-RS or SSB resources, for example, as described herein with respect to FIGS. 8, 13A, and 13B. The second group of CSI-RS or SSB resources may be configured with a one-to-N association (FIG. 13A) or M-to-N association (FIG. 13B) with the first group of CSI-RS or SSB resources, for example. In certain aspects, each resource in the second group of one or more CSI-RS or SSB resources may be associated with a plurality of resources in the first group of one or more CSI-RS or SSB resources. In certain cases, there may be a one-to-one association between a resource in the first group of CSI-RS or SSB resources and another resource in the second group of CSI-RS or SSB resources.

In certain aspects, the first and second groups of CSI-RS or SSB resources may be configured in the same CSI resource set of a CSI report setting, for example, as described herein with respect to FIG. 10. For example, the CSI report setting (through a CSI resource setting) may identify a CSI resource set (e.g., the CSI-ResourceSet #1 in FIG. 10) indicating the first group of one or more CSI-RS or SSB resources and the second group of one or more CSI-RS or SSB resources.

For certain aspects, the first and second groups of CSI-RS or SSB resources may be configured in different CSI resource sets in the same CSI report setting, for example, as described herein with respect to FIG. 11. The CSI report setting (through a CSI resource setting) may identify a first CSI resource set indicating the first group of CSI-RS or SSB resources and a second CSI resource set indicating the second group of CSI-RS or SSB resources.

In certain cases, the UE may receive an indication that the CSI report setting is not limited by all the resources having the same periodicity and/or having a single resource set in a CSI resource setting for periodic or semi-persistent resources. The UE may receive an indication that the CSI report setting may identify groups of CSI-RS/SSB resources with different periodicities and/or identify the groups of CSI-RS/SSB resources in different CSI resource sets for periodic or semi-persistent resources. The UE may receive signaling that indicates that the CSI report setting identifies the first group of one or more CSI-RS or SSB resources and the second group of one or more CSI-RS or SSB resources as having different periodicities or in different CSI resource sets. As used herein, signaling may include radio resource control (RRC) signaling, downlink control information (DCI), medium access control (MAC) signaling, and/or system information. As an example, the UE may be configured with a particular control parameter (e.g., WidePredictNarrow, which may be an RRC control field) indicating that a CSI report setting may allow for a wide beam based narrow beam prediction, such that the CSI report setting may identify groups of CSI-RS/SSB resources with different periodicities and/or identify the groups of CSI-RS/SSB resources in different CSI resource sets. The control parameter may be indicated in a separate information element than the CSI report setting or in the CSI report setting.

In some cases, the UE may be configured with a separate type of CSI report setting that is not limited by all the resources having the same periodicity and/or having a single resource set in a CSI resource setting for periodic or semi-persistent resources. For example, the UE may be configured with a particular CSI report setting and/or a particular CSI resource settings, such as a release or purpose specific CSI report setting and/or CSI resource setting (e.g., CSI-ReportConfig-Rel19 or CSI-ResourceConfig-Rel19). The purpose specific CSI report or resource setting may be for wide beam based narrow beam prediction/estimation, for example. The CSI report setting may be a particular setting that supports identifying (or is allowed to identify) CSI-RS or SSB resource groups having different periodicities and/or in different CSI resource sets for periodic or semi-persistent CSI-RS or SSB resources. In certain aspects, the CSI report setting identifies a CSI resource setting that supports identifying (or is allowed to identify) a plurality of resource sets for periodic or semi-persistent CSI-RS or SSB resources, for example, as depicted in FIG. 11.

In certain cases, the UE may be configured with a CSI report setting that identifies a particular resource type (e.g., PeriodicForBeamPredict and/or SPSForBeamPredict) that indicates the CSI report setting is not limited by all the resources having the same periodicity and/or having a single resource set in a CSI resource setting for periodic or semi-persistent resources. The CSI report setting identifies a particular resource type that indicates that the CSI report setting supports identifying CSI-RS or SSB resource groups having different periodicities for periodic or semi-persistent CSI-RS or SSB resources; the CSI report setting identifies a resource setting that supports identifying a plurality of resource sets for periodic or semi-persistent CSI-RS or SSB resources; or a combination thereof.

For certain aspects, the first and second groups of CSI-RS or SSB resources may be configured with multiple CSI report settings, for example, as described herein with respect to FIG. 12. As an example, the first group of CSI-RS or SSB resources (e.g., the narrow beam CSI-RS/SSB resources) may be configured by a first CSI resource setting associated with a first CSI report setting, and the second group of CSI-RS or SSB resources (e.g., the wide beam CSI-RS/SSB resources) may be configured by a second CSI resource setting associated with a second CSI report setting.

The first CSI report setting may identify that the second CSI report setting is associated with the first CSI report setting. For example, the first CSI report setting may include a separate field that identifies the second CSI report setting, such as a BeamPredictLink-CSI-ReportConfig field as depicted in FIG. 12.

The first CSI report setting may indicate to report properties (e.g., RSRPs of CSI-RSs or SSBs) associated with the first group of CSI-RS or SSB resources and/or the second group of CSI-RS or SSB resources, for example, via the reportQuantity field. For example, the report quantity of the first CSI report may only indicate to report properties associated with the first group of CSI-RS/SSB resources. In certain cases, the report quantity of the first CSI report may also indicate to report properties associated with the second group of CSI-RS/SSB resources, which may enable the wide beam based prediction/estimation of the narrow beams. The second CSI report setting may have a report quantity field set to none (e.g., an indication that there are no quantities to report for the resources).

As an example, the CSI report setting may include a first CSI report setting (e.g., CSI-ReportConfig #1 for the narrow beam resources as depicted in FIG. 12) indicating the first group of CSI-RS or SSB resources and a second CSI report setting (e.g., CSI-ReportConfig #2 for the wide beam resources as depicted in FIG. 12) indicating the second group of CSI-RS or SSB resources. The first CSI report setting may identify that the second CSI report setting is associated with the first CSI report setting, or vice versa. For example, a separate field of a CSI report setting may identify another CSI report setting associated with the CSI report setting for purpose of reporting wide beam based properties of narrow beams. The first CSI report setting may include a field (e.g., reportQuantity) indicating to report one or more properties (e.g., RSRP) associated with one or more CSI-RS or SSB resources in at least one of the first group of CSI-RS or SSB resources or the second group of CSI-RS or SSB resources. The second CSI report setting may include the field indicating there are no quantities to report (e.g., reportQuantity=none).

In certain aspects, the UE may be configured with implicit or explicit associations between the first group of CSI-RS or SSB resources and the second group of CSI-RS or SSB resources, such as the associations described herein with respect to FIG. 13A and/or FIG. 13B. As an example implicit association, the narrow beam CSI-RS/SSB resources may have a QCL relationship the wide beam CSI-RS/SSB resources. For example, N CSI-RS/SSB resources in the narrow beam group may have a QCL relationship with one of the CSI-RS/SSB resources in the wide beam group. The QCL relationship may be indicated, for example, via a TCI state. The UE may receive signaling that indicates one or more QCL relationships associated with the second group of CSI-RS or SSB resources and the first group of CSI-RS or SSB resources. In certain cases, each resource in the second group of CSI-RS or SSB resources may be associated with a plurality of resources in the first group of CSI-RS or SSB resources based at least in part on the QCL relationships. Each resource in the second group of CSI-RS or SSB resources may have a QCL relationship with a plurality of resources in the first group of CSI-RS or SSB resources. In some cases, the QCL relationships of a wide beam CSI-RS or SSB resource may overlap with the QCL relationship of another wide beam CSI-RS or SSB resource, for example, as depicted in FIG. 13B.

As examples of explicit associations, the UE may receive an explicit indication that the reported properties (e.g., RSRPs of CSI-RSs or SSBs) associated with the CSI-RS/SSB resources in a certain sub-group of the narrow beam CSI-RS/SSB resources may be calculated based at least on one or more CSI-RS/SSB resources in the wide beam group. The UE may receive an explicit indication that a sub-group of N CSI-RS/SSB resources in the narrow beam group may be linear/non-linear combinations of a sub-group of M CSI-RS/SSB resources in the wide beam group. In certain cases, the combination formulas may be explicitly configured or provided. The UE may receive an explicit indication that a sub-group of N CSI-RS/SSB resources in the narrow beam group may have a certain offset in terms of an angular metric or spatial parameter (e.g., AoD, ZoD, and/or FoV offset) relative to a CSI-RS/SSB resource in the wide beam group. The offset values for the angular metric or spatial parameter may explicitly configured or provided.

The UE may receive signaling that includes a first indication providing (or indicating) that properties (e.g., an RSRP) for a plurality of resources in the first group of CSI-RS or SSB resources may be determined based on one or more measurements for at least one resource in the second group of CSI-RS or SSB resources. The signaling may include a second indication providing that at least one resource in the second group of one or more CSI-RS or SSB resources corresponds to a linear combination of the plurality of resources in the first group of one or more CSI-RS or SSB resources. The signaling may include a third indication providing that at least one resource in the second group of one or more CSI-RS or SSB resources corresponds to a non-linear combination of the plurality of resources in the first group of one or more CSI-RS or SSB resources. The signaling may include a fourth indication providing that offset values for the plurality of resources in the first group of one or more CSI-RS or SSB resources are in terms of an angular metric (e.g., AoA) or a spatial parameter (e.g., FoV or spatial channel correlation) relative to at least one resource in the second group of one or more CSI-RS or SSB resources. The signaling may include the first indication, the second indication, the third indication, the fourth indication, or any combination thereof.

The properties reported for the CSI associated with the CSI-RS/SSB resources in the wide beam group and/or narrow beam group may be configured by the network. For example, the UE may report a single or multiple properties associated with the CSI-RS/SSB resources in the wide beam group and/or narrow beam group. In certain aspects, the UE may only report properties (e.g., RSRPs of SSBs or CSI-RSs) associated with the CSI-RS/SSB resources in in the narrow beam group (e.g., the first group of CSI-RS or SSB resources), and such properties may be derived from measurements of the wide beam group of CSI-RS/SSB resources (e.g., the second group of CSI-RS or SSB resources). The CSI-RS and/or SSB resources for which the properties will be reported may be indicated by an SSB resource index and/or a CSI-RS resource index. In some aspects, the UE may report properties for the CSI-RS/SSB resources in the wide beam group and narrow beam group.

The network may configure the UE with the number SSB/CSI-RS resources that can be reported in the CSI. If the UE is capable of reporting CSI associated with the wide beam group and the narrow beam group, the UE may determine how to allocate the number of beams (resources) to be reported. In certain aspects, the UE may determine how to allocate the number of beams to be reported across the different sub-groups associated with the wide beam and narrow beam groups, for example, the sub-group associations depicted in FIG. 13A and/or FIG. 13B. The UE may provide, to the network, determination on the number of resources to report per sub-group and/or group among the wide beam and narrow beam groups. The UE may provide the determination on the number of resources to report per sub-group and/or group in the CSI report or in separate signaling to the network.

The CSI report setting may further indicate to report one or more properties (e.g., RSRP) associated with one or more CSI-RS or SSB resources in at least one of the first group of one or more CSI-RS or SSB resources or the second group of one or more CSI-RS or SSB resources. The CSI may include one or more measurements or properties associated with one or more resources in at least one of the first group of one or more CSI-RS or SSB resources or the second group of one or more CSI-RS or SSB resources. In certain cases, the CSI may include one or more measurements or properties associated with one or more resources only in the second group of one or more CSI-RS or SSB resources, where the second group of has a shorter periodicity than the first group of one or more CSI-RS or SSB resources.

In some cases, the UE may receive signaling that indicates a number of the one or more measurements associated with the one or more resources to report in the CSI. The UE may report the CSI based at least in part on the number of the one or more measurements.

In some cases, the UE may transmit, to the network entity, an indication of the one or more resources that are reported in the CSI, where the one or more resources may be a subset of resources in the first group of one or more CSI-RS or SSB resources and the second group of one or more CSI-RS or SSB resources. In certain cases, the CSI may include the indication of the resources reported in the CSI.

In certain cases, a UE may be capable of processing a certain number of simultaneous CSI processing activities and/or CSI calculations, where simultaneous may refer to occurring at the same period of time, for example, occurring within the same symbol. A CSI processing unit may include one or more CSI processing activities or calculations. For example, if a UE supports N_{CPU} simultaneous CSI calculations, the UE is said to have N_{CPU} CSI processing units for processing CSI reports. If L CPUs are occupied for calculation of CSI reports in a given OFDM symbol (or other suitable duration), the UE has N_{CPU}—L unoccupied CPUs. A UE may not be expected to process CSI calculations that occupy more than the N_{CPU} in a given symbol.

The number of occupied CPUs for the CSI reporting described herein may be determined based on various criteria. In certain cases, the number of occupied CPUs may be determined based on the number of configured CSI-RS/SSB resources for the wide beam group and/or the narrow beam group. For example, if X SSB resources are in the first group and Y CSI-RS resources are in the second group are configured, the corresponding number of occupied CPUs may be equal to aX+bY, where the values of a and b can be standards predefined, network configured, or UE determined (and/or recommended to the network).

In some cases, the number of occupied CPUs may be determined based on the periodicities of the CSI-RS/SSB resources in the first group and/or the second group. For example, if the X SSB resources in the first group has a periodicity of M-ms, and the Y CSI-RS resources in the second group has a periodicity of N-ms, the corresponding number of occupied CPUs may be equal to

$$\frac{a}{M} X + \frac{b}{N} Y ,$$

where the values of a and b can be standards predefined, network configured, or UE determined (and/or recommended to the network).

In certain cases, the number of occupied CPUs may be determined based on the number of resources (e.g., ssb-Index-RSRP(s) or cri-RSRP(s)) to be reported in the CSI for the CSI-RS/SSB resources in the first group and/or the second group. For example, if x sri-Index-RSRPs and y cri-RSRPs are to be reported from the X SSB resources in the first group with a periodicity of M-ms and the Y CSI-RS resources in the second group with a periodicity of N-ms, the corresponding number of occupied CPUs may be equal to

$$\frac{a}{M} xX + \frac{b}{N} yY ,$$

wherein the values of a and b can be standards predefined, network configured, or UE determined (and/or recommended to the network).

The UE may process the CSI in compliance with a threshold (e.g., N_{CPU} simultaneous CSI calculations) for simultaneous CSI calculations. For example, the UE may process the CSI if the number of simultaneous CSI calculations (e.g., the number of occupied CPUs) for the CSI and/or other CSI processing operations in one or more symbols is less than or equal to the threshold. The number of the simultaneous CSI calculations (e.g., the number of occupied CPUs) associated with the CSI report setting may be determined based at least in part on a number of resources in at least one of the first group of one or more CSI-RS or SSB resources or the second group of one or more CSI-RS or SSB resources. In certain cases, the number of occupied CPUs associated with the CSI report setting may be determined based at least in part on a periodicity for at least one of the first group of one or more CSI-RS or SSB resources or the second group of one or more CSI-RS or SSB resources. In some cases, the number of occupied CPUs associated with the CSI report setting may be determined based at least in part on a number of measurements to be reported for at least one of the first group of one or more CSI-RS or SSB resources or the second group of one or more CSI-RS or SSB resources.

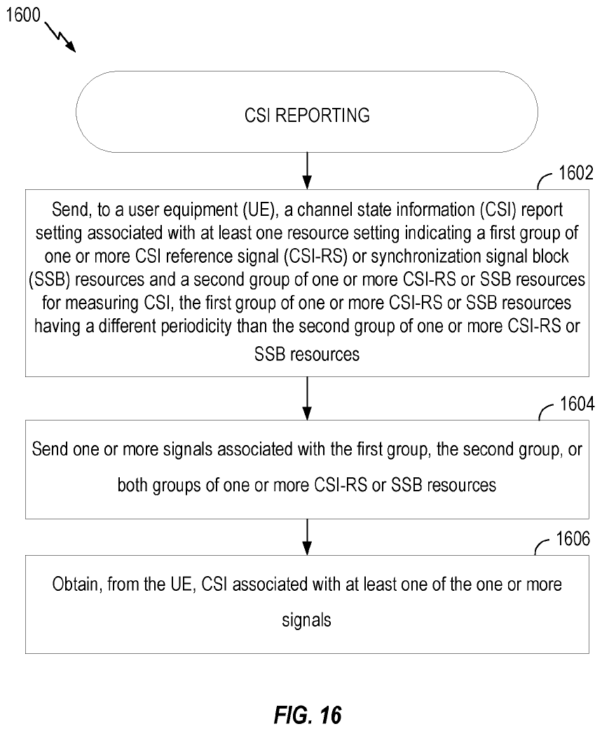

FIG. 16 is a flow diagram illustrating example operations 1600 for wireless communication, in accordance with certain aspects of the present disclosure. The operations 1600 may be performed, for example, by a network entity (such as the BS 102 in the wireless communications system 100). The operations 1600 may be complementary to the operations 1500 performed by the UE. The operations 1500 may be implemented as software components that are executed and run on one or more processors (e.g., controller/processor 240 of FIG. 2). Further, the transmission and reception of signals by the network entity in operations 1500 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, the network entity may refer to a wireless communication device in a radio access network, such as a base station, a remote radio head or antenna panel in communication with a base station, and/or a network controller.

The operations 1600 may optionally begin, at block 1602, where the network entity may send (e.g., transmit or provide), to a UE (e.g., the UE 104), a CSI report setting (e.g., CSI-ReportConfig #1 in FIG. 10) associated with at least one resource setting (e.g., CSI-ResourceConfig #1 in FIG. 10) indicating a first group of one or more CSI-RS) or synchronization signal block (SSB) resources and a second group of one or more CSI-RS or SSB resources for measuring CSI. As the first group of CSI-RS or SSB resources and second group of one or more CSI-RS or SSB resources may be periodic and/or semi-persistent resources, the first group of one or more CSI-RS or SSB resources may have a different periodicity than the second group of one or more CSI-RS or SSB resources.

At block 1604, the network entity may send one or more signals associated with the first group, the second group, or both groups (the first and second groups) of one or more CSI-RS or SSB resources. For example, the network entity may transmit CSI-RSs/SSBs associated with the second group of CSI-RS or SSB resources, which may have a shorter periodicity than the first group of CSI-RS or SSB resources.

At block 1606, the network entity may obtain (e.g., receive), from the UE, CSI associated with at least one of the one or more signals. For example, the network entity may receive properties associated the first group of CSI-RS or SSB resources based on measurements of the second group of CSI-RS or SSB resources, as described herein with respect to FIG. 6. In certain aspects, the network entity may determine, based on the reported CSI, resource allocations or other transmission configuration parameters for the UE. The transmission configuration parameters may include, for example, the modulation and coding scheme (MCS), the coding rate (e.g., the proportion of the data-stream that is non-redundant), the number of aggregated component carriers, the number of MIMO layers, the bandwidth, the subcarrier spacing, the frequency range (e.g., FR1 or FR2), etc.

In certain aspects, the first group of CSI-RS or SSB resources may have a different number of resources (e.g., a greater number of resources) than the second group of CSI-RS or SSB resources.

In some aspects, the network entity may receive, from the UE, capability information related to reporting CSI for resources with different periodicities, for example, as described herein with respect to FIG. 9. The network entity may receive an indication that the UE has a capability to report measurements associated with CSI-RS or SSB resource groups having different periodicities. The network entity may transmit the CSI report setting based on (e.g., in response to) the indication.

For certain aspects, the first group of CSI-RS or SSB resources may be associated with the second group of CSI-RS or SSB resources, for example, as described herein with respect to FIGS. 8, 13A, and 13B. For example, each resource in the second group of one or more CSI-RS or SSB resources may be associated with a plurality of resources in the first group of one or more CSI-RS or SSB resources.

In certain aspects, the first and second groups of CSI-RS or SSB resources may be configured in the same CSI resource set of a CSI report setting. For example, the CSI report setting may identify a CSI resource set indicating the first group of one or more CSI-RS or SSB resources and the second group of one or more CSI-RS or SSB resources.

For certain aspects, the first and second groups of CSI-RS or SSB resources may be configured in different CSI resource sets in the same CSI report setting. For example, the CSI report setting may identify a first CSI resource set indicating the first group of one or more CSI-RS or SSB resources and a second CSI resource set indicating the second group of one or more CSI-RS or SSB resources.

In certain cases, the network entity may transmit an indication that the CSI report setting is not limited by all the resources having the same periodicity and/or having a single resource set in a CSI resource setting for periodic or semi-persistent resources. The network entity may transmit an indication that the CSI report setting may identify groups of CSI-RS/SSB resources with different periodicities and/or identify the groups of CSI-RS/SSB resources in different CSI resource sets for periodic or semi-persistent resources. For example, the network entity may transmit signaling that indicates that the CSI report setting identifies the first group of one or more CSI-RS or SSB resources and the second group of one or more CSI-RS or SSB resources.

In some cases, the network may configure the UE with a separate type of CSI report setting that is not limited by all the resources having the same periodicity and/or having a single resource set in a CSI resource setting for periodic or semi-persistent resources. The CSI report setting may be a particular setting that supports identifying CSI-RS or SSB resource groups having different periodicities. The CSI report setting may identify a resource setting that supports identifying a plurality of resource sets for periodic or semi-persistent CSI-RS or SSB resources.

In certain cases, the network may configure the UE with a CSI report setting that identifies a particular resource type (e.g., PeriodicForBeamPredict and/or SPSForBeamPredict) that indicates the CSI report setting is not limited by all the resources having the same periodicity and/or having a single resource set in a CSI resource setting for periodic or semi-persistent resources. The CSI report setting may identify a particular resource type that indicates that the CSI report setting supports identifying CSI-RS or SSB resource groups having different periodicities; the CSI report setting identifies a resource setting that supports identifying a plurality of resource sets for periodic or semi-persistent CSI-RS or SSB resources; or a combination thereof.

For certain aspects, the first and second groups of CSI-RS or SSB resources may be configured with multiple CSI report settings, for example, as described herein with respect to FIG. 12. The CSI report setting may include a first CSI report setting indicating the first group of CSI-RS or SSB resources and a second CSI report setting indicating the second group of CSI-RS or SSB resources. The second CSI report setting may identify that the first CSI report setting is associated with the second CSI report setting. In the first CSI report setting includes a field indicating to report one or more properties (e.g., RSRP) associated with one or more CSI-RS or SSB resources in at least one of the first group of CSI-RS or SSB resources or the second group of CSI-RS or SSB resources. The second CSI report setting may include the field indicating there are no quantities to report.

In certain aspects, the network entity may configure the UE with implicit or explicit associations between the first group of CSI-RS or SSB resources and the second group of CSI-RS or SSB resources, such as the associations described herein with respect to FIG. 13A and/or FIG. 13B. For example, the network entity may transmit signaling that indicates QCL relationships associated with the second group of CSI-RS or SSB resources and the first group of CSI-RS or SSB resources. Each resource in the second group of CSI-RS or SSB resources may be associated with a plurality of resources in the first group of CSI-RS or SSB resources based at least in part on the QCL relationships.

For explicit indications of the associations, the network entity may transmit signaling that includes a first indication providing that properties for a plurality of resources in the first group of one or more CSI-RS or SSB resources are based on one or more measurements for at least one resource in the second group of one or more CSI-RS or SSB resources. The signaling may include a second indication providing that the at least one resource in the second group of one or more RS resources corresponds to a linear combination of the plurality of resources in the first group of one or more CSI-RS or SSB resources. The signaling may include a third indication providing that the at least one resource in the second group of one or more CSI-RS or SSB resources corresponds to a non-linear combination of the plurality of resources in the first group of one or more CSI-RS or SSB resources. The signaling may include a fourth indication providing that offset values for the plurality of resources in the first group of one or more RS resources are in terms of an angular metric relative to the at least one resource in the second group of one or more CSI-RS or SSB resources. The signaling may include the first indication, the second indication, the third indication, the fourth indication, or any combination thereof.

The network entity may configure the UE with the properties reported for the CSI associated with the CSI-RS/SSB resources in the wide beam group and/or narrow beam group. The CSI report setting may indicate for the UE to report one or more properties (e.g., RSRP) associated with one or more CSI-RS or SSB resources in at least one of the first group of CSI-RS or SSB resources or the second group of CSI-RS or SSB resources. The network entity may receive the CSI with the properties associated with the one or more CSI-RS or SSB resources based on the indication. The CSI may include measurements or properties associated with one or more resources in at least one of the first group of one or more CSI-RS or SSB resources or the second group of one or more CSI-RS or SSB resources. In certain cases, the CSI may include one or more measurements or properties associated with one or more resources only in the second group of CSI-RS or SSB resources, where the second group of has a shorter periodicity than the first group of one or more CSI-RS or SSB resources.

The network entity may transmit signaling that indicates a number of the one or more measurements or properties associated with the one or more resources to report. The network entity may receive the CSI based at least in part on the number of the one or more measurements or properties.

In some cases, the network entity may receive, from the UE, an indication of the one or more resources that are reported in the CSI, where the one or more resources are a subset of resources in the first group of CSI-RS or SSB resources and the second group of CSI-RS or SSB resources. In certain cases, the CSI may include the indication of the resources reported in the CSI.

The number of occupied CPUs for the CSI reporting described herein may be determined based on various criteria. The number of occupied CPUs associated with the CSI report setting may be determined based at least in part on a number of resources in at least one of the first group of one or more CSI-RS or SSB resources or the second group of one or more CSI-RS or SSB resources, a periodicity for at least one of the first group of one or more CSI-RS or SSB resources or the second group of one or more CSI-RS or SSB resources, a number of measurements to be reported for at least one of the first group of one or more CSI-RS or SSB resources or the second group of one or more CSI-RS or SSB resources, or a combination thereof.

While the examples are described herein with respect to configuring and reporting CSI for CSI-RS/SSB resources in a wide beam group and a narrow beam group to facilitate understanding, aspects of the present disclosure may also be applied to configuring and reporting CSI for CSI-RS/SSB resources in other types of groups, such as groups with different periodicities, different spatial parameters, different carriers, etc.

Deployment of communication systems, such as 5G new radio (NR) systems, may be arranged in multiple manners with various components or constituent parts. In a 5G NR system (or network), a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

### Example Disaggregated RAN

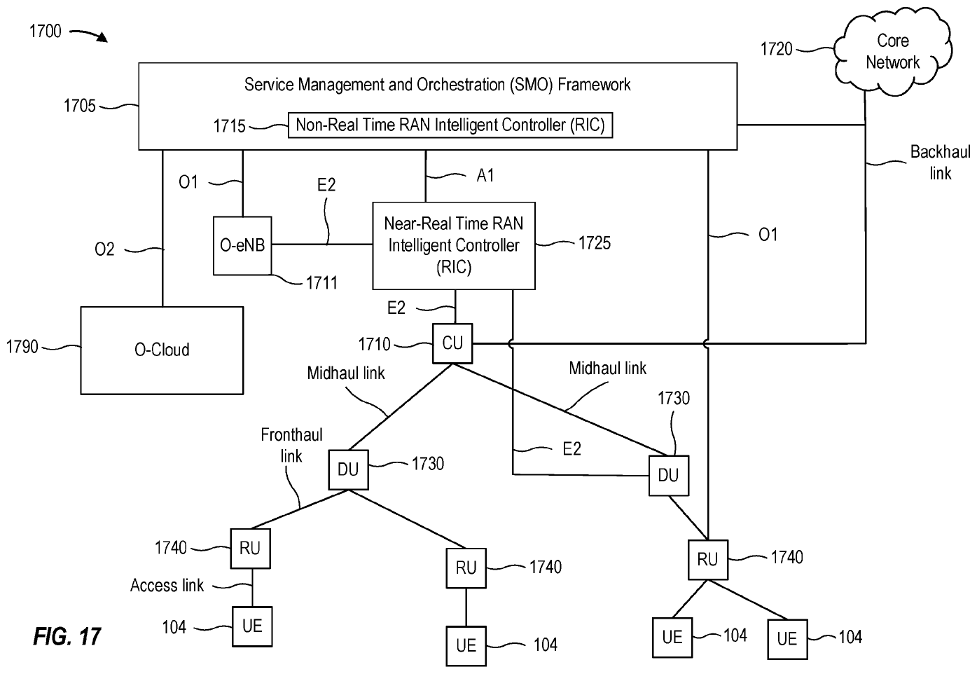

FIG. 17 shows a diagram illustrating an example disaggregated base station 1700 architecture. The disaggregated base station 1700 architecture may include one or more central units (CUs) 1710 that can communicate directly with a core network 1720 via a backhaul link, or indirectly with the core network 1720 through one or more disaggregated base station units (such as a Near-Real Time (Near-RT) RAN Intelligent Controller (RIC) 1725 via an E2 link, or a Non-Real Time (Non-RT) RIC 1715 associated with a Service Management and Orchestration (SMO) Framework 1705, or both). A CU 1710 may communicate with one or more distributed units (DUs) 1730 via respective midhaul links, such as an F1 interface. The DUs 1730 may communicate with one or more radio units (RUs) 1740 via respective fronthaul links. The RUs 1740 may communicate with respective UEs 104 via one or more radio frequency (RF) access links. In some implementations, the UE 104 may be simultaneously served by multiple RUs 1740.

Each of the units, i.e., the CUs 1710, the DUs 1730, the RUs 1740, as well as the Near-RT RICs 1725, the Non-RT RICs 1715 and the SMO Framework 1705, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1710 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1710. The CU 1710 may be configured to handle user plane functionality (i.e., Central Unit-User Plane (CU-UP)), control plane functionality (i.e., Central Unit-Control Plane (CU-CP)), or a combination thereof. In some implementations, the CU 1710 can be logically split into one or more CU-UP units and one or more CU-CP units. The CU-UP unit can communicate bidirectionally with the CU-CP unit via an interface, such as the E1 interface when implemented in an O-RAN configuration. The CU 1710 can be implemented to communicate with the DU 1730, as necessary, for network control and signaling.

The DU 1730 may correspond to a logical unit that includes one or more base station functions to control the operation of one or more RUs 1740. In some aspects, the DU 1730 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 1730 may further host one or more low PHY layers. Each layer (or module) can be implemented with an interface configured to communicate signals with other layers (and modules) hosted by the DU 1730, or with the control functions hosted by the CU 1710.

Lower-layer functionality can be implemented by one or more RUs 1740. In some deployments, an RU 1740, controlled by a DU 1730, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1740 can be implemented to handle over the air (OTA) communication with one or more UEs 104. In some implementations, real-time and non-real-time aspects of control and user plane communication with the RU(s) 1740 can be controlled by the corresponding DU 1730. In some scenarios, this configuration can enable the DU(s) 1730 and the CU 1710 to be implemented in a cloud-based RAN architecture, such as a vRAN architecture.

The SMO Framework 1705 may be configured to support RAN deployment and provisioning of non-virtualized and virtualized network elements. For non-virtualized network elements, the SMO Framework 1705 may be configured to support the deployment of dedicated physical resources for RAN coverage requirements which may be managed via an operations and maintenance interface (such as an O1 interface). For virtualized network elements, the SMO Framework 1705 may be configured to interact with a cloud computing platform (such as an open cloud (O-Cloud) 1790) to perform network element life cycle management (such as to instantiate virtualized network elements) via a cloud computing platform interface (such as an O2 interface). Such virtualized network elements can include, but are not limited to, CUs 1710, DUs 1730, RUs 1740 and Near-RT RICs 1725. In some implementations, the SMO Framework 1705 can communicate with a hardware aspect of a 4G RAN, such as an open eNB (O-eNB) 1711, via an O1 interface. Additionally, in some implementations, the SMO Framework 1705 can communicate directly with one or more RUs 1740 via an O1 interface. The SMO Framework 1705 also may include a Non-RT RIC 1715 configured to support functionality of the SMO Framework 1705.

The Non-RT RIC 1715 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1725. The Non-RT RIC 1715 may be coupled to or communicate with (such as via an A1 interface) the Near-RT RIC 1725. The Near-RT RIC 1725 may be configured to include a logical function that enables near-real-time control and optimization of RAN elements and resources via data collection and actions over an interface (such as via an E2 interface) connecting one or more CUs 1710, one or more DUs 1730, or both, as well as an O-eNB, with the Near-RT RIC 1725.

In some implementations, to generate AI/ML models to be deployed in the Near-RT RIC 1725, the Non-RT RIC 1715 may receive parameters or external enrichment information from external servers. Such information may be utilized by the Near-RT RIC 1725 and may be received at the SMO Framework 1705 or the Non-RT RIC 1715 from non-network data sources or from network functions. In some examples, the Non-RT RIC 1715 or the Near-RT RIC 1725 may be configured to tune RAN behavior or performance. For example, the Non-RT RIC 1715 may monitor long-term trends and patterns for performance and employ AI/ML models to perform corrective actions through the SMO Framework 1705 (such as reconfiguration via 01) or via creation of RAN management policies (such as A1 policies).

### Example Wireless Communication Devices

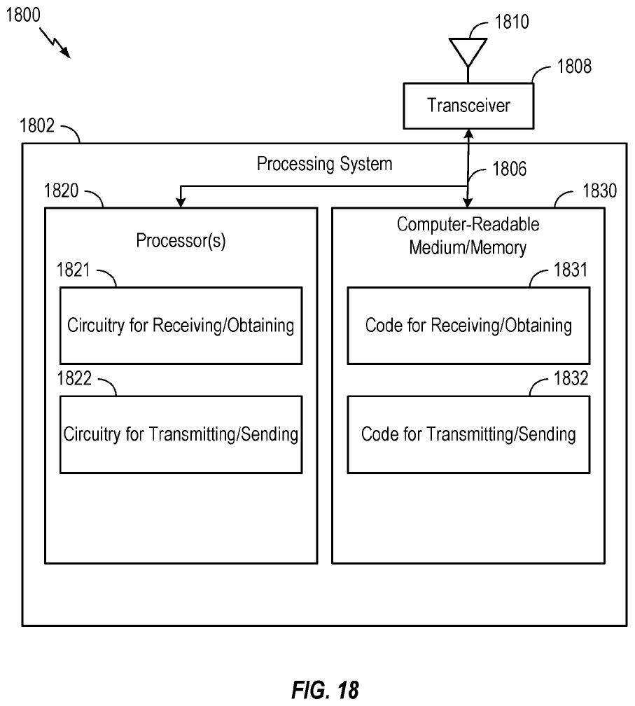

FIG. 18 depicts an example communications device 1800 that includes various components operable, configured, or adapted to perform operations for the techniques disclosed herein, such as the operations depicted and described with respect to FIGS. 7-14 and 16. In some examples, communication device 1800 may be a base station 102 as described, for example with respect to FIGS. 1 and 2.

Communications device 1800 includes a processing system 1802 coupled to a transceiver 1808 (e.g., a transmitter and/or a receiver). Transceiver 1808 is configured to transmit (or send) and receive signals for the communications device 1800 via an antenna 1810, such as the various signals as described herein. Processing system 1802 may be configured to perform processing functions for communications device 1800, including processing signals received and/or to be transmitted by communications device 1800.

Processing system 1802 includes one or more processors 1820 coupled to a computer-readable medium/memory 1830 via a bus 1806. In certain aspects, computer-readable medium/memory 1830 is configured to store instructions (e.g., computer-executable code) that when executed by the one or more processors 1820, cause the one or more processors 1820 to perform the operations illustrated in FIGS. 7-14 and 16, or other operations for performing the various techniques discussed herein for configuring and receiving CSI associated with groups of CSI-RS/SSB resource with different periodicities.

In the depicted example, computer-readable medium/memory 1830 stores code 1831 for receiving/obtaining and/or code 1832 for transmitting/sending.

In the depicted example, the one or more processors 1820 include circuitry configured to implement the code stored in the computer-readable medium/memory 1830, including circuitry 1821 for receiving/obtaining and/or circuitry 1822 for transmitting/sending.

Various components of communications device 1800 may provide means for performing the methods described herein, including with respect to FIGS. 7-14 and 16.

In some examples, means for transmitting or sending (or means for outputting for transmission) may include the transceivers 232 and/or antenna(s) 234 of the base station 102 illustrated in FIG. 2 and/or transceiver 1808 and antenna 1810 of the communication device 1800 in FIG. 18.

In some examples, means for receiving (or means for obtaining) may include the transceivers 232 and/or antenna(s) 234 of the base station illustrated in FIG. 2 and/or transceiver 1808 and antenna 1810 of the communication device 1800 in FIG. 18.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for transmitting and/or receiving may include various processing system components, such as: the one or more processors 1820 in FIG. 18, or aspects of the base station 102 depicted in FIG. 2, including receive processor 238, transmit processor 220, TX MIMO processor 230, and/or controller/processor 240 (including beam estimation/prediction component 241).

Notably, FIG. 18 is an example, and many other examples and configurations of communication device 1800 are possible.

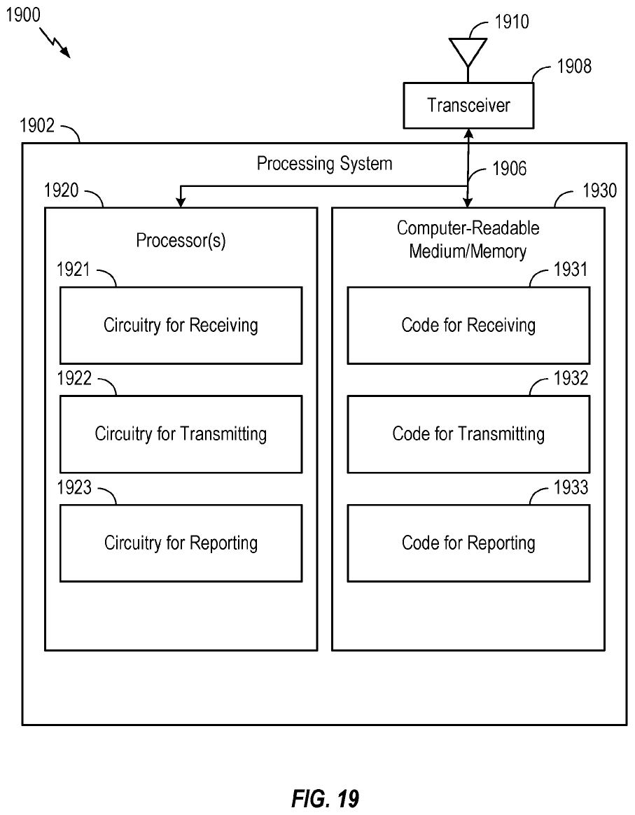

FIG. 19 depicts an example communications device 1900 that includes various components operable, configured, or adapted to perform operations for the techniques disclosed herein, such as the operations depicted and described with respect to FIGS. 7-15. In some examples, communication device 1900 may be a user equipment 104 as described, for example with respect to FIGS. 1 and 2.

Communications device 1900 includes a processing system 1902 coupled to a transceiver 1908 (e.g., a transmitter and/or a receiver). Transceiver 1908 is configured to transmit (or send) and receive signals for the communications device 1900 via an antenna 1910, such as the various signals as described herein. Processing system 1902 may be configured to perform processing functions for communications device 1900, including processing signals received and/or to be transmitted by communications device 1900.

Processing system 1902 includes one or more processors 1920 coupled to a computer-readable medium/memory 1930 via a bus 1906. In certain aspects, computer-readable medium/memory 1930 is configured to store instructions (e.g., computer-executable code) that when executed by the one or more processors 1920, cause the one or more processors 1920 to perform the operations illustrated in FIGS. 7-15, or other operations for performing the various techniques discussed herein for configuring and reporting CSI associated with groups of CSI-RS/SSB resource with different periodicities.

In the depicted example, computer-readable medium/memory 1930 stores code 1931 for receiving, code 1932 for transmitting, and/or code 1933 for reporting.

In the depicted example, the one or more processors 1920 include circuitry configured to implement the code stored in the computer-readable medium/memory 1930, including circuitry 1921 for receiving, circuitry 1922 for transmitting, and/or circuitry 1923 for reporting.

Various components of communications device 1900 may provide means for performing the methods described herein, including with respect to FIGS. 7-15.

In some examples, means for transmitting or sending (or means for outputting for transmission) may include the transceivers 254 and/or antenna(s) 252 of the user equipment 104 illustrated in FIG. 2 and/or transceiver 1908 and antenna 1910 of the communication device 1900 in FIG. 19.

In some examples, means for receiving (or means for obtaining) may include the transceivers 254 and/or antenna(s) 252 of the user equipment 104 illustrated in FIG. 2 and/or transceiver 1908 and antenna 1910 of the communication device 1900 in FIG. 19.

In some examples, means for transmitting, receiving, and/or reporting may include various processing system components, such as: the one or more processors 1920 in FIG. 19, or aspects of the user equipment 104 depicted in FIG. 2, including receive processor 258, transmit processor 264, TX MIMO processor 266, and/or controller/processor 280 (including beam estimation/prediction component 281).

Notably, FIG. 19 is an example, and many other examples and configurations of communication device 1900 are possible.

### Example Aspects

Implementation examples are described in the following numbered clauses:

Aspect 1: An apparatus for wireless communication, comprising: a memory; and a processor coupled to the memory, the processor and the memory being configured to: receive a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources, and report CSI associated with the first group, the second group, or the first group and the second group of one or more monitored CSI-RS or SSB resources.

Aspect 2: The apparatus of Aspect 1, further comprising a transceiver coupled to the processor and the memory, wherein the transceiver is configured to receive the CSI report setting and report the CSI; and wherein the first group of one or more CSI-RS or SSB resources has a different number of resources than the second group of one or more CSI-RS or SSB resources.

Aspect 3: The apparatus of Aspect 1 or 2, wherein the processor is further configured to: receive the CSI report setting, which further indicates to report a reference signal received power (RSRP) associated with one or more CSI-RS or SSB resources in at least one of the first group of one or more CSI-RS or SSB resources or the second group of one or more CSI-RS or SSB resources, and report the CSI indicating the RSRP associated with the one or more CSI-RS or SSB resources.

Aspect 4: The apparatus according to any of Aspects 1-3, wherein the processor is further configured to transmit an indication that the apparatus has a capability to report measurements associated with the first group and the second group of one or more CSI-RS or SSB resources having different periodicities.

Aspect 5: The apparatus according to any of Aspects 1-4, wherein the processor is further configured to receive signaling indicating that the CSI report setting identifies the first group of one or more CSI-RS or SSB resources and the second group of one or more CSI-RS or SSB resources.

Aspect 6: The apparatus according to any of Aspects 1-5, wherein each resource in the second group of one or more CSI-RS or SSB resources is associated with a plurality of resources in the first group of one or more CSI-RS or SSB resources.

Aspect 7: The apparatus according to any of Aspects 1-6, wherein the CSI report setting identifies a CSI resource set indicating the first group of one or more CSI-RS or SSB resources and the second group of one or more CSI-RS or SSB resources.

Aspect 8: The apparatus according to any of Aspects 1-16, wherein the CSI report setting identifies a first CSI resource set indicating the first group of one or more CSI-RS or SSB resources and a second CSI resource set indicating the second group of one or more CSI-RS or SSB resources.

Aspect 9: The apparatus according to any of Aspects 1-6, wherein: the CSI report setting includes a first CSI report setting indicating the first group of one or more CSI-RS or SSB resources and a second CSI report setting indicating the second group of one or more CSI-RS or SSB resources; and the second CSI report setting identifies that the first CSI report setting is associated with the second CSI report setting.

Aspect 10: The apparatus according to any of Aspects 1-9, wherein the processor is further configured to: receive signaling indicating one or more quasi co-location (QCL) relationships associated with the second group of one or more CSI-RS or SSB resources and the first group of one or more CSI-RS or SSB resources; and each resource in the second group of one or more CSI-RS or SSB resources is associated with a plurality of resources in the first group of one or more CSI-RS or SSB resources based at least in part on the one or more QCL relationships.

Aspect 11: The apparatus according to any of Aspects 1-10, wherein the processor is further configured to receive signaling that includes: a first indication that properties for a plurality of resources in the first group of one or more CSI-RS or SSB resources are based on one or more measurements for at least one resource in the second group of one or more CSI-RS or SSB resources; a second indication that the at least one resource in the second group of one or more CSI-RS or SSB resources corresponds to a linear combination of the plurality of resources in the first group of one or more CSI-RS or SSB resources; a third indication that the at least one resource in the second group of one or more CSI-RS or SSB resources corresponds to a non-linear combination of the plurality of resources in the first group of one or more CSI-RS or SSB resources; a fourth indication that offset values for the plurality of resources in the first group of one or more CSI-RS or SSB resources are in terms of an angular metric relative to the at least one resource in the second group of one or more CSI-RS or SSB resources; or a combination thereof.

Aspect 12: The apparatus according to any of Aspects 1-11, wherein the CSI comprises one or more measurements associated with one or more resources in at least one of the first group of one or more CSI-RS or SSB resources or the second group of one or more CSI-RS or SSB resources.

Aspect 13: The apparatus according to any of Aspects 1-11, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

Aspect 14: The apparatus according to any of Aspects 1-13, wherein the processor is further configured to: process the CSI in compliance with a threshold for simultaneous CSI calculations, wherein a number for the simultaneous CSI calculations associated with the CSI report setting is based at least in part on: a number of resources in at least one of the first group of one or more CSI-RS or SSB resources or the second group of one or more CSI-RS or SSB resources, a periodicity for at least one of the first group of one or more CSI-RS or SSB resources or the second group of one or more CSI-RS or SSB resources, or a number of measurements to be reported for at least one of the first group of one or more CSI-RS or SSB resources or the second group of one or more CSI-RS or SSB resources.

Aspect 15: An apparatus for wireless communication, comprising: a memory; and a processor coupled to the memory, the processor and the memory being configured to: send, to a user equipment (UE), a channel state information (CSI) report setting associated with at least one resource setting indicating a first group of one or more CSI reference signal (CSI-RS) or synchronization signal block (SSB) resources and a second group of one or more CSI-RS or SSB resources for measuring CSI, the first group of one or more CSI-RS or SSB resources having a different periodicity than the second group of one or more CSI-RS or SSB resources, send one or more signals associated with the first group, the second group, or the first group and the second group of one or more CSI-RS or SSB resources, and obtain, from the UE, CSI associated with at least one of the one or more signals.

Aspect 16: The apparatus of Aspect 15, further comprising a transceiver coupled to the processor and the memory, wherein the transceiver is configured to send the CSI report setting, send the one more signals, and obtain the CSI; and wherein the first group of one or more CSI-RS or SSB resources has a different number of resources than the second group of one or more CSI-RS or SSB resources.

Aspect 17: The apparatus of Aspect 15 or 16, wherein the processor is further configured to send the CSI report setting, which further indicates to report a reference signal received power (RSRP) associated with one or more CSI-RS or SSB resources in at least one of the first group of one or more CSI-RS or SSB resources or the second group of one or more CSI-RS or SSB resources; and the processor is further configured to obtain the CSI with an RSRP associated with the one or more CSI-RS or SSB resources based on the indication.

Aspect 18: The apparatus according to any of Aspects 15-17, wherein the processor is further configured to: obtain an indication that the UE has a capability to report measurements associated with the first group and the second group of one or more CSI-RS or SSB resources having different periodicities, and send the CSI report setting based on the indication.

Aspect 19: The apparatus according to any of Aspects 15-18, wherein the processor is further configured to send signaling indicating that the CSI report setting identifies the first group of one or more CSI-RS or SSB resources and the second group of one or more CSI-RS or SSB resources.

Aspect 20: The apparatus according to any of Aspects 15-19, wherein each resource in the second group of one or more CSI-RS or SSB resources is associated with a plurality of resources in the first group of one or more CSI-RS or SSB resources.

Aspect 21: The apparatus according to any of Aspects 15-20, wherein the CSI report setting identifies a CSI resource set indicating the first group of one or more CSI-RS or SSB resources and the second group of one or more CSI-RS or SSB resources.

Aspect 22: The apparatus according to any of Aspects 15-20, wherein the CSI report setting identifies a first CSI resource set indicating the first group of one or more CSI-RS or SSB resources and a second CSI resource set indicating the second group of one or more CSI-RS or SSB resources.

Aspect 23: The apparatus according to any of Aspects 15-20, wherein: the CSI report setting includes a first CSI report setting indicating the first group of one or more CSI-RS or SSB resources and a second CSI report setting indicating the second group of one or more CSI-RS or SSB resources; and the second CSI report setting identifies that the first CSI report setting is associated with the second CSI report setting.

Aspect 24: The apparatus according to any of Aspects 15-23, wherein the processor is further configured to: send signaling indicating one or more quasi co-location (QCL) relationships associated with the second group of one or more CSI-RS or SSB resources and the first group of one or more CSI-RS or SSB resources; and each resource in the second group of one or more CSI-RS or SSB resources is associated with a plurality of resources in the first group of one or more CSI-RS or SSB resources based at least in part on the one or more QCL relationships.

Aspect 25: The apparatus according to any of Aspects 15-24, wherein the processor is further configured to send signaling that includes: a first indication indicating that properties for a plurality of resources in the first group of one or more CSI-RS or SSB resources are based on one or more measurements for at least one resource in the second group of one or more CSI-RS or SSB resources; a second indication indicating that the at least one resource in the second group of one or more CSI-RS or SSB resources corresponds to a linear combination of the plurality of resources in the first group of one or more CSI-RS or SSB resources; a third indication indicating that the at least one resource in the second group of one or more CSI-RS or SSB resources corresponds to a non-linear combination of the plurality of resources in the first group of one or more CSI-RS or SSB resources; a fourth indication indicating that offset values for the plurality of resources in the first group of one or more RS resources are in terms of an angular metric relative to the at least one resource in the second group of one or more CSI-RS or SSB resources; or a combination thereof.

Aspect 26: The apparatus according to any of Aspects 15-25, wherein the CSI comprises measurements associated with one or more resources in at least one of the first group of one or more CSI-RS or SSB resources or the second group of one or more CSI-RS or SSB resources.

Aspect 27: The apparatus according to any of Aspects 15-25, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

Aspect 28: A method of wireless communication by a user equipment, comprising: receiving a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources; and reporting CSI associated with the first group, the second group, or the first group and the second group of one or more monitored CSI-RS or SSB resources.

Aspect 29: The method of Aspect 28, wherein: the first group of one or more CSI-RS or SSB resources has a different number of resources than the second group of one or more CSI-RS or SSB resources.

Aspect 30: The method of Aspect 28 or 29, wherein the CSI report setting further indicates to report a reference signal received power (RSRP) associated with one or more CSI-RS or SSB resources in at least one of the first group of one or more CSI-RS or SSB resources or the second group of one or more CSI-RS or SSB resources.

Aspect 31: The method according to any of Aspects 28-30, further comprising transmitting an indication that the user equipment has a capability to report measurements associated with the first group and the second group of one or more CSI-RS or SSB resources having different periodicities.

Aspect 32: The method according to any of Aspects 28-31, wherein receiving further comprises receiving signaling indicating that the CSI report setting identifies the first group of one or more CSI-RS or SSB resources and the second group of one or more CSI-RS or SSB resources.

Aspect 33: The method according to any of Aspects 28-32, wherein each resource in the second group of one or more CSI-RS or SSB resources is associated with a plurality of resources in the first group of one or more CSI-RS or SSB resources.

Aspect 34: The method according to any of Aspects 28-33, wherein the CSI report setting identifies a CSI resource set indicating the first group of one or more CSI-RS or SSB resources and the second group of one or more CSI-RS or SSB resources.

Aspect 35: The method according to any of Aspects 28-33, wherein the CSI report setting identifies a first CSI resource set indicating the first group of one or more CSI-RS or SSB resources and a second CSI resource set indicating the second group of one or more CSI-RS or SSB resources.

Aspect 36: The method according to any of Aspects 28-35, wherein the CSI report setting is a particular setting that supports identifying CSI-RS or SSB resource groups having different periodicities.

Aspect 37: The method according to any of Aspects 28-36, wherein the CSI report setting identifies a resource setting that supports identifying a plurality of resource sets for periodic or semi-persistent CSI-RS or SSB resources.

Aspect 38: The method according to any of Aspects 28-37, wherein the CSI report setting identifies a particular resource type that indicates that: the CSI report setting supports identifying CSI-RS or SSB resource groups having different periodicities; the CSI report setting identifies a resource setting that supports identifying a plurality of resource sets for periodic or semi-persistent CSI-RS or SSB resources; or a combination thereof.

Aspect 39: The method according to any of Aspects 28-33 or 36-37, wherein: the CSI report setting includes a first CSI report setting indicating the first group of one or more CSI-RS or SSB resources and a second CSI report setting indicating the second group of one or more CSI-RS or SSB resources; and the second CSI report setting identifies that the first CSI report setting is associated with the second CSI report setting.

Aspect 40: The method of Aspect 39, wherein: the first CSI report setting includes a field indicating to report a reference signal received power (RSRP) associated with one or more CSI-RS or SSB resources in at least one of the first group of one or more CSI-RS or SSB resources or the second group of one or more CSI-RS or SSB resources; and the second CSI report setting includes the field indicating there are no quantities to report.

Aspect 41: The method according to any of Aspects 28-40, wherein: receiving comprises receiving signaling indicating one or more quasi co-location (QCL) relationships associated with the second group of one or more CSI-RS or SSB resources and the first group of one or more CSI-RS or SSB resources; and each resource in the second group of one or more CSI-RS or SSB resources is associated with a plurality of resources in the first group of one or more CSI-RS or SSB resources based at least in part on the one or more QCL relationships.

Aspect 42: The method according to any of Aspects 28-41, wherein receiving comprises receiving signaling that includes: a first indication indicating that properties for a plurality of resources in the first group of one or more CSI-RS or SSB resources are based on one or more measurements for at least one resource in the second group of one or more CSI-RS or SSB resources; a second indication indicating that the at least one resource in the second group of one or more CSI-RS or SSB resources corresponds to a linear combination of the plurality of resources in the first group of one or more CSI-RS or SSB resources; a third indication indicating that the at least one resource in the second group of one or more CSI-RS or SSB resources corresponds to a non-linear combination of the plurality of resources in the first group of one or more CSI-RS or SSB resources; a fourth indication indicating that offset values for the plurality of resources in the first group of one or more CSI-RS or SSB resources are in terms of an angular metric relative to the at least one resource in the second group of one or more CSI-RS or SSB resources; or a combination thereof.

Aspect 43: The method according to any of Aspects 28-42, wherein the CSI comprises one or more measurements associated with one or more resources in at least one of the first group of one or more CSI-RS or SSB resources or the second group of one or more CSI-RS or SSB resources.

Aspect 44: The method according to any of Aspects 28-42, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

Aspect 45: The method of Aspect 43, wherein: receiving comprises receiving signaling indicating a number of the one or more measurements associated with the one or more resources to report; and reporting the CSI based at least in part on the number of the one or more measurements.

Aspect 46: The method of Aspects 43 or 45, further comprising transmitting an indication of the one or more resources that are reported in the CSI, wherein the one or more resources are a subset of resources in the first group of one or more CSI-RS or SSB resources and the second group of one or more CSI-RS or SSB resources.

Aspect 47: The method according to any of Aspects 43, 45, or 46, wherein reporting the CSI comprises transmitting an indication of the one or more resources that are reported in the CSI, wherein the one or more resources are a subset of resources in the first group of one or more CSI-RS or SSB resources and the second group of one or more CSI-RS or SSB resources.

Aspect 48: The method according to any of Aspects 28-47, wherein reporting the CSI comprises: processing the CSI in compliance with a threshold for simultaneous CSI calculations, wherein a number for the simultaneous CSI calculations associated with the CSI report setting is based at least in part on: a number of resources in at least one of the first group of one or more CSI-RS or SSB resources or the second group of one or more CSI-RS or SSB resources, a periodicity for at least one of the first group of one or more CSI-RS or SSB resources or the second group of one or more CSI-RS or SSB resources, or a number of measurements to be reported for at least one of the first group of one or more CSI-RS or SSB resources or the second group of one or more CSI-RS or SSB resources.

Aspect 49: A method of wireless communication by a network entity, comprising: sending, to a user equipment (UE), a channel state information (CSI) report setting associated with at least one resource setting indicating a first group of one or more CSI reference signal (CSI-RS) or synchronization signal block (SSB) resources and a second group of one or more CSI-RS or SSB resources for measuring CSI, the first group of one or more CSI-RS or SSB resources having a different periodicity than the second group of one or more CSI-RS or SSB resources; sending one or more signals associated with the first group, the second group, or the first group and the second group of one or more CSI-RS or SSB resources; and obtaining, from the UE, CSI associated with at least one of the one or more signals.

Aspect 50: The method of Aspect 49, wherein: the first group of one or more CSI-RS or SSB resources has a different number of resources than the second group of one or more CSI-RS or SSB resources.

Aspect 51: The method of Aspect 49 or 50, wherein: the CSI report setting indicates to report a reference signal received power (RSRP) associated with one or more CSI-RS or SSB resources in at least one of the first group of one or more CSI-RS or SSB resources or the second group of one or more CSI-RS or SSB resources; and obtaining the CSI comprises obtaining the CSI indicating an RSRP associated with the one or more CSI-RS or SSB resources based on the indication.

Aspect 52: The method according to any of Aspects 49-51, further comprising: obtaining an indication that the UE has a capability to report measurements associated with CSI-RS or SSB resource groups having different periodicities; and wherein sending the CSI report setting comprises sending the CSI report setting based on the indication.

Aspect 53: The method according to any of Aspects 49-52, wherein sending comprises sending signaling indicating that the CSI report setting identifies the first group of one or more CSI-RS or SSB resources and the second group of one or more CSI-RS or SSB resources.

Aspect 54: The method according to any of Aspects 49-53, wherein each resource in the second group of one or more CSI-RS or SSB resources is associated with a plurality of resources in the first group of one or more CSI-RS or SSB resources.

Aspect 55: The method according to any of Aspects 49-54, wherein the CSI report setting identifies a CSI resource set indicating the first group of one or more CSI-RS or SSB resources and the second group of one or more CSI-RS or SSB resources.

Aspect 56: The method according to any of Aspect 49-54, wherein the CSI report setting identifies a first CSI resource set indicating the first group of one or more CSI-RS or SSB resources and a second CSI resource set indicating the second group of one or more CSI-RS or SSB resources.

Aspect 57: The method according to any of Aspects 49-56, wherein the CSI report setting is a particular setting that supports identifying CSI-RS or SSB resource groups having different periodicities.

Aspect 58: The method according to any of Aspects 49-57, wherein the CSI report setting identifies a resource setting that supports identifying a plurality of resource sets for periodic or semi-persistent CSI-RS or SSB resources.

Aspect 59: The method according to any of Aspects 49-58, wherein the CSI report setting identifies a particular resource type that indicates that: the CSI report setting supports identifying CSI-RS or SSB resource groups having different periodicities; the CSI report setting identifies a resource setting that supports identifying a plurality of resource sets for periodic or semi-persistent CSI-RS or SSB resources; or a combination thereof.

Aspect 60: The method according to any of Aspects 49-54, wherein: the CSI report setting includes a first CSI report setting indicating the first group of one or more CSI-RS or SSB resources and a second CSI report setting indicating the second group of one or more CSI-RS or SSB resources; and the second CSI report setting identifies that the first CSI report setting is associated with the second CSI report setting.

Aspect 61: The method of Aspect 60, wherein: the first CSI report setting includes a field indicating to report a reference signal received power (RSRP) associated with one or more CSI-RS or SSB resources in at least one of the first group of one or more CSI-RS or SSB resources or the second group of one or more CSI-RS or SSB resources; and the second CSI report setting includes the field indicating there are no quantities to report.

Aspect 62: The method according to any of Aspects 49-61, wherein: sending the CSI report setting comprises sending signaling indicating one or more quasi co-location (QCL) relationships associated with the second group of one or more CSI-RS or SSB resources and the first group of one or more CSI-RS or SSB resources; and each resource in the second group of one or more CSI-RS or SSB resources is associated with a plurality of resources in the first group of one or more CSI-RS or SSB resources based at least in part on the one or more QCL relationships.

Aspect 63: The method according to any of Aspects 49-62, wherein sending the CSI report setting comprises sending signaling that includes: a first indication indicating that properties for a plurality of resources in the first group of one or more CSI-RS or SSB resources are based on one or more measurements for at least one resource in the second group of one or more CSI-RS or SSB resources; a second indication indicating that the at least one resource in the second group of one or more CSI-RS or SSB resources corresponds to a linear combination of the plurality of resources in the first group of one or more CSI-RS or SSB resources; a third indication indicating that the at least one resource in the second group of one or more CSI-RS or SSB resources corresponds to a non-linear combination of the plurality of resources in the first group of one or more CSI-RS or SSB resources; a fourth indication indicating that offset values for the plurality of resources in the first group of one or more RS resources are in terms of an angular metric relative to the at least one resource in the second group of one or more CSI-RS or SSB resources; or a combination thereof.

Aspect 64: The method according to any of Aspects 49-63, wherein the CSI comprises measurements associated with one or more resources in at least one of the first group of one or more CSI-RS or SSB resources or the second group of one or more CSI-RS or SSB resources.

Aspect 65: The method according to any of Aspects 49-63, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

Aspect 66: The method of Aspect 65, wherein: sending the CSI report setting comprises sending signaling indicating a number of the one or more measurements associated with the one or more resources to report; and obtaining the CSI comprises obtaining the CSI based at least in part on the number of the one or more measurements.

Aspect 67: The method of Aspect 64, further comprising obtaining an indication of the one or more resources that are reported in the CSI, wherein the one or more resources are a subset of resources in the first group of one or more CSI-RS or SSB resources and the second group of one or more CSI-RS or SSB resources.

Aspect 68: The method of Aspect 64 or 67, wherein obtaining the CSI comprises obtaining an indication of the one or more resources that are reported in the CSI, wherein the one or more resources are a subset of resources in the first group of one or more CSI-RS or SSB resources and the second group of one or more CSI-RS or SSB resources.

Aspect 69: The method according to any of Aspects 49-68, wherein a number for simultaneous CSI calculations associated with the CSI report setting is based at least in part on: a number of resources in at least one of the first group of one or more CSI-RS or SSB resources or the second group of one or more CSI-RS or SSB resources, a periodicity for at least one of the first group of one or more CSI-RS or SSB resources or the second group of one or more CSI-RS or SSB resources, or a number of measurements to be reported for at least one of the first group of one or more CSI-RS or SSB resources or the second group of one or more CSI-RS or SSB resources.

Aspect 70: An apparatus, comprising: a memory comprising executable instructions; one or more processors configured to execute the executable instructions and cause the apparatus to perform a method in accordance with any of Aspects 28-69.

Aspect 71: An apparatus, comprising means for performing a method in accordance with any of Aspects 28-69.

Aspect 72: A computer-readable medium comprising executable instructions that, when executed by one or more processors of an apparatus, cause the apparatus to perform a method in accordance with any of Aspects 28-69.

Aspect 73: A computer program product embodied on a computer-readable storage medium comprising code for performing a method in accordance with any of Aspects 28-69.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an TP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where P is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of channel state information reporting in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMITS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
a memory; and
a processor coupled to the memory, the processor being configured to:
receive a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources, and
report CSI associated with the first group, the second group, or the first group and the second group of one or more monitored CSI-RS or SSB resources.

2. The apparatus of claim 1, further comprising:
a transceiver coupled to the processor and the memory, wherein the transceiver is configured to receive the CSI report setting and report the CSI; and
wherein the first group of one or more CSI-RS or SSB resources has a different number of resources than the second group of one or more CSI-RS or SSB resources.

3. The apparatus of claim 1, wherein the processor is further configured to:
receive the CSI report setting, which further indicates to report a reference signal received power (RSRP) associated with one or more CSI-RS or SSB resources in at least one of the first group of one or more CSI-RS or SSB resources or the second group of one or more CSI-RS or SSB resources, and
report the CSI indicating the RSRP associated with the one or more CSI-RS or SSB resources.

4. The apparatus of claim 1, wherein the processor is further configured to transmit an indication that the apparatus has a capability to report measurements associated with the first group and the second group of one or more CSI-RS or SSB resources having different periodicities.

5. The apparatus of claim 1, wherein the processor is further configured to receive signaling indicating that the CSI report setting identifies the first group of one or more CSI-RS or SSB resources and the second group of one or more CSI-RS or SSB resources.

6. The apparatus of claim 1, wherein each resource in the second group of one or more CSI-RS or SSB resources is associated with a plurality of resources in the first group of one or more CSI-RS or SSB resources.

7. The apparatus of claim 1, wherein the CSI report setting identifies a CSI resource set indicating the first group of one or more CSI-RS or SSB resources and the second group of one or more CSI-RS or SSB resources.

8. The apparatus of claim 1, wherein the CSI report setting identifies a first CSI resource set indicating the first group of one or more CSI-RS or SSB resources and a second CSI resource set indicating the second group of one or more CSI-RS or SSB resources.

9. The apparatus of claim 1, wherein:
the CSI report setting includes a first CSI report setting indicating the first group of one or more CSI-RS or SSB resources and a second CSI report setting indicating the second group of one or more CSI-RS or SSB resources; and
the second CSI report setting identifies that the first CSI report setting is associated with the second CSI report setting.

10. The apparatus of claim 1, wherein the processor is further configured to:
receive signaling indicating one or more quasi co-location (QCL) relationships associated with the second group of one or more CSI-RS or SSB resources and the first group of one or more CSI-RS or SSB resources; and
each resource in the second group of one or more CSI-RS or SSB resources is associated with a plurality of resources in the first group of one or more CSI-RS or SSB resources based at least in part on the one or more QCL relationships.

11. The apparatus of claim 1, wherein the processor is further configured to receive signaling that includes:
a first indication indicating that properties for a plurality of resources in the first group of one or more CSI-RS or SSB resources are based on one or more measurements for at least one resource in the second group of one or more CSI-RS or SSB resources;
a second indication indicating that the at least one resource in the second group of one or more CSI-RS or SSB resources corresponds to a linear combination of the plurality of resources in the first group of one or more CSI-RS or SSB resources;
a third indication indicating that the at least one resource in the second group of one or more CSI-RS or SSB resources corresponds to a non-linear combination of the plurality of resources in the first group of one or more CSI-RS or SSB resources;
a fourth indication indicating that offset values for the plurality of resources in the first group of one or more CSI-RS or SSB resources are in terms of an angular metric relative to the at least one resource in the second group of one or more CSI-RS or SSB resources; or
a combination thereof.

12. The apparatus of claim 1, wherein the CSI comprises one or more measurements associated with one or more resources in at least one of the first group of one or more CSI-RS or SSB resources or the second group of one or more CSI-RS or SSB resources.

13. The apparatus of claim 1, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

14. The apparatus of claim 1, wherein the processor is further configured to:
process the sf for simultaneous CSI calculations, wherein a number for the simultaneous CSI calculations associated with the CSI report setting is based at least in part on:
a number of resources in at least one of the first group of one or more CSI-RS or SSB resources or the second group of one or more CSI-RS or SSB resources,
a periodicity for at least one of the first group of one or more CSI-RS or SSB resources or the second group of one or more CSI-RS or SSB resources, or
a number of measurements to be reported for at least one of the first group of one or more CSI-RS or SSB resources or the second group of one or more CSI-RS or SSB resources.

15. An apparatus for wireless communication, comprising:
a memory; and
a processor coupled to the memory, the processor being configured to:
send, to a user equipment (UE), a channel state information (CSI) report setting associated with at least one resource setting indicating a first group of one or more CSI reference signal (CSI-RS) or synchronization signal block (SSB) resources and a second group of one or more CSI-RS or SSB resources for measuring CSI, the first group of one or more CSI-RS or SSB resources having a different periodicity than the second group of one or more CSI-RS or SSB resources,
send one or more signals associated with the first group, the second group, or the first group and the second group of one or more CSI-RS or SSB resources, and
obtain, from the UE, CSI associated with at least one of the one or more signals.

16. The apparatus of claim 15, further comprising:
a transceiver coupled to the processor and the memory, wherein the transceiver is configured to send the CSI report setting, send the one more signals, and obtain the CSI; and
wherein the first group of one or more CSI-RS or SSB resources has a different number of resources than the second group of one or more CSI-RS or SSB resources.

17. The apparatus of claim 15, wherein the processor is further configured to:
send the CSI report setting, which indicates to report a reference signal received power (RSRP) associated with one or more CSI-RS or SSB resources in at least one of the first group of one or more CSI-RS or SSB resources or the second group of one or more CSI-RS or SSB resources, and
obtain the CSI indicating the RSRP associated with the one or more CSI-RS or SSB resources based on the indication.

18. The apparatus of claim 15, wherein the processor is further configured to:
obtain an indication that the UE has a capability to report measurements associated with the first group and the second group of one or more CSI-RS or SSB resources having different periodicities, and
send the CSI report setting in response to the indication.

19. The apparatus of claim 15, wherein the processor is further configured to send signaling indicating that the CSI report setting identifies the first group of one or more CSI-RS or SSB resources and the second group of one or more CSI-RS or SSB resources.

20. The apparatus of claim 15, wherein each resource in the second group of one or more CSI-RS or SSB resources is associated with a plurality of resources in the first group of one or more CSI-RS or SSB resources.

21. The apparatus of claim 15, wherein the CSI report setting identifies a CSI resource set indicating the first group of one or more CSI-RS or SSB resources and the second group of one or more CSI-RS or SSB resources.

22. The apparatus of claim 15, wherein the CSI report setting identifies a first CSI resource set indicating the first group of one or more CSI-RS or SSB resources and a second CSI resource set indicating the second group of one or more CSI-RS or SSB resources.

23. The apparatus of claim 15, wherein:
the CSI report setting includes a first CSI report setting indicating the first group of one or more CSI-RS or SSB resources and a second CSI report setting indicating the second group of one or more CSI-RS or SSB resources; and
the second CSI report setting identifies that the first CSI report setting is associated with the second CSI report setting.

24. The apparatus of claim 15, wherein the processor is further configured to:
send signaling indicating one or more quasi co-location (QCL) relationships associated with the second group of one or more CSI-RS or SSB resources and the first group of one or more CSI-RS or SSB resources; and
each resource in the second group of one or more CSI-RS or SSB resources is associated with a plurality of resources in the first group of one or more CSI-RS or SSB resources based at least in part on the one or more QCL relationships.

25. The apparatus of claim 15, wherein the processor is further configured to send signaling that includes:
a first indication indicating that properties for a plurality of resources in the first group of one or more CSI-RS or SSB resources are based on one or more measurements for at least one resource in the second group of one or more CSI-RS or SSB resources;
a second indication indicating that the at least one resource in the second group of one or more CSI-RS or SSB resources corresponds to a linear combination of the plurality of resources in the first group of one or more CSI-RS or SSB resources;
a third indication indicating that the at least one resource in the second group of one or more CSI-RS or SSB resources corresponds to a non-linear combination of the plurality of resources in the first group of one or more CSI-RS or SSB resources;
a fourth indication indicating that offset values for the plurality of resources in the first group of one or more RS resources are in terms of an angular metric relative to the at least one resource in the second group of one or more CSI-RS or SSB resources; or
a combination thereof.

26. The apparatus of claim 15, wherein the CSI comprises measurements associated with one or more resources in at least one of the first group of one or more CSI-RS or SSB resources or the second group of one or more CSI-RS or SSB resources.

27. The apparatus of claim 15, wherein the CSI comprises one or more measurements associated with one or more resources only in the second group of one or more CSI-RS or SSB resources, wherein the second group of one or more CSI-RS or SSB resources has a shorter periodicity than the first group of one or more CSI-RS or SSB resources.

28. A method of wireless communication by a user equipment, comprising:
receiving a channel state information (CSI) report setting associated with at least one resource setting that indicates a first group of one or more CSI reference signal (CSI-RS) or synchronization signal block (SSB) resources and a second group of one or more CSI-RS or SSB resources, the first group of one or more CSI-RS or SSB resources having a different periodicity than the second group of one or more CSI-RS or SSB resources; and
reporting CSI associated with the first group, the second group, or the first group and the second group of one or more monitored CSI-RS or SSB resources.

29. The method of claim 28, wherein:
the first group of one or more CSI-RS or SSB resources has a different number of resources than the second group of one or more CSI-RS or SSB resources.

30. A method of wireless communication by a network entity, comprising:
sending, to a user equipment (UE), a channel state information (CSI) report setting associated with at least one resource setting indicating a first group of one or more CSI reference signal (CSI-RS) or synchronization signal block (SSB) resources and a second group of one or more CSI-RS or SSB resources for measuring CSI, the first group of one or more CSI-RS or SSB resources having a different periodicity than the second group of one or more CSI-RS or SSB resources;
sending one or more signals associated with the first group, the second group, or the first group and the second group of one or more CSI-RS or SSB resources; and
obtaining, from the UE, CSI associated with at least one of the one or more signals.
